(19) United States
(12) Patent Application Publication
(10) Pub. No.: US 2009/0168419 A1
(43) Pub. Date: Jul. 2, 2009

(54) Light Emission Device and Light Emitter Using the Same

(76) Inventor: Sueyoshi Daimon, Saitama (JP)

Correspondence Address: Ronald R. Snider, P.O.Box 27613, Washington, DC, 20038-7613, US

(21) Appl. No.: 11/884,712

(22) PCT Filed: Feb. 24, 2006
(86) PCT No.: PCT/JP2006/303484

§ 371 Date: Aug. 20, 2007

(30) Foreign Application Priority Data
Feb. 24, 2005 (JP) 2005-049817
Aug. 9, 2005 (JP) 2005-231420

(51) Int. Cl. F21V 1/00

(52) U.S. Cl. 362/235

(57) ABSTRACT

The present invention aims at: emitting a uniform light on the whole with a high luminance to provide a required bright illumination; suppressing increase of temperature and reducing power consumption; and permitting easy alteration of entire shape and size thereof.

A light emission device 10 is provided, which comprises: a transparent element 30 of columnar shape having a substantially circular shape in section; a light cover 12 attached on outer surface of the transparent element 30 so as to securely sandwich and retain that particular outer surface of transparent element; and a plurality of LEDs 22 for applying lights to the transparent element 30, the plurality of LEDs 22 being provided in the light cover 12. Such LEDs 22 are disposed relative to said transparent element 30, such that a predetermined space I is essentially given between the LEDs 22 and the surface of the transparent element 30. Upon lights being emitted from the LEDs 22, the lights expands freely in an air zone between the LEDs 22 and the transparent element 30 and are therefore applied to that particular transparent element 30 from many angles. Then, the lights are refracted and diffused due to a lens effect of the transparent element 30, and emitted from an opening area 14 of the light cover 12 to the outside. When such light emission is viewed from the outside, it is observed that a whole of the transparent element 30 is illuminated uniformly with a high luminance.

### TECHNICAL FIELD

The present invention relates to a light emission device and a light emitter using the light emission device. More particularly, the invention is directed to an improvement of a light emission device which comprises a transparent element and a means for introducing a light into and through the transparent element, as well as to an improvement of light emitter using that light emission device, in order to materialize a high luminance and uniformity of a light emitted therefrom.

### BACKGROUND ART

Lighting equipment or luminaire, such as a fluorescent lamp, used in individual homes, offices, hospitals and other facilities, has a reflector member disposed behind or laterally of a light source. With such arrangement, a light emitted from the light source (e.g. fluorescent lamp or incandescent lamp) is directed to the reflector member and reflected thereby in a desired direction to a side or object to be illuminated. Due to such light reflection effect, a luminance of the lighting equipment used becomes higher, and further, the light emitted therefrom are scattered by a wide reflective surface of the reflector member, hence providing a soft and gentle light on the whole. Hitherto, such reflector member uses a coating material applied thereto, which contains a white pigment including titan oxide or the like. But, this sort of coating material has been with the problem that it absorbs a relatively high rate of energy (approx. 14 to 17%) of visible light regions in a light applied thereto, and therefore, an illumination efficiency becomes lower by that absorbed rate of visible light energy. Moreover, the lighting equipment of this kind, by the reason of its having the reflector member, is rather complicated in structure and uneasy to be assembled with other elements. Recently, a LED (light-emitting diode) has received a great attention in terms of its low power consumption and high illumination efficiency, and a great number of various lighting equipments, each incorporating the LED as a light source, have been proposed and produced. For example, disclosed from the under-listed patent literature 1 is a lighting equipment which uses a small number of LEDs therein and is capable of causing lights emitted from the LEDs to illuminate a surface of object in a relatively uniform manner.

The Patent Literature 1: Japanese Laid-Open Patent Publication No. 2003-77312

### DISCLOSURE OF THE INVENTION

### Problems to be Solved by the Present Invention

However, in general, many of lighting equipments using LEDs are faced with the problem that the light quantity thereof is low and insufficient relative to that of the incandescent lamp or the like, and therefore, a sufficient luminance may not be attained for required purpose, depending on a circumstance where the lighting equipment is installed or used. In particular, in the case of a linear (rectilinear) form of lighting equipment using one single LED, it is generally conceived that the lighting region thereof becomes higher in luminance as it proceeds closer to a light source, while becoming lower in luminance as it proceeds away from the light source, and therefore, it is of a high likelihood that an uneven luminance of light may be applied from the lighting equipment on the whole to an object which will thus be illuminated unevenly therewith. To tide over such problem, the above-cited patent literature 1 teaches disposition of a plurality of LEDs in one single direction as well as provision of reflector means (reflector parts) therealong.

Each of the LEDs used in the foregoing reference is, however, of an ordinary shape having a substantially bullet-like contour. Thus, in order to create and emit a band of light from a longitudinal body of the luminaire of such prior art, it is required to dispose the LEDs such that they are in contact with one another, without any space thereamong, and also to keep the LEDs away a predetermined distance (e.g. approx. 300 mm) from an object to be illuminated thereby. This arrangement is inevitably required in view of the fact that each of the LEDs themselves emit a light in the form of “a point of light” only. Consequently, if it is desired to create a uniform band of light of a more satisfied luminance with such prior art, additional many numbers of LEDs are required to be arranged in the foregoing manner, which nonetheless results in being a bar to reduction of power consumption and in undesired increase in size of the lighting equipment as well as in costs for assembly of that lighting equipment. The same goes for another alternative arrangements of the LEDs, such as a ring arrangement of LEDs. What is worse, if such many arrays of LEDs remain in “on” state for continued emission of the band of light, a temperature surrounding them is inevitably increased to a certain high degree, although such increased degree of temperature is lower than an increased degree of temperature caused by many fluorescent lamps or incandescent lamps used in the same situation.

With the above-stated drawbacks in view, it is a purpose of the present invention to provide a light emission device and a light emitter using the same, which is capable of: emitting a uniform light from an entire body thereof, with a high luminance, to provide a satisfied bright illumination that can serve any required purposes; preventing increase of temperature; attaining a low power consumption; and further permitting for easy alteration of shape and sizes of the entire body thereof.

### Means for Solving the Problems

In order to achieve the foregoing purpose, a light emission device of the present invention is characterized by comprising: a transparent element having a curved surface region of substantially arcuate or circular shape in section, the transparent element having a property that allows substantive light to pass therethrough; at least one light source for emitting and applying light to the curved surface region, the at least one light source being disposed adjacent to and out of contact with a surface of the transparent element, or disposed a predetermined distance from the surface of the transparent element, so as to allow the light to pass through the transparent element and radiate outwardly therefrom; and a cover means provided on an outer surface of the transparent element, the cover means having the afore-said at least one light source accommodated therein.

Another mode of light emission device in accordance with the present invention is characterized by comprising: a transparent element of substantially spherical shape having a property that allows substantive light to pass therethrough; at least one light source for emitting light exteriorly of the transparent element and applying the light to that particular transparent element, wherein such at least one light source is disposed adjacent to and out of contact with an outer circumferential surface of the transparent element, or disposed a predetermined distance from the outer circumferential surface of the transparent element; and a tubular portion in which the afore-said at least one light source is accommodated, the tubular portion being defined on the outer circumferential surface of the transparent element.

Still another mode of light emission device in accordance with the present invention is characterized by comprising: a transparent element of substantially semispherical shape having a property that allows substantive light to pass therethrough; at least one light source for emitting light exteriorly of the transparent element and applying the light to that particular transparent element, wherein such at least one light source is disposed adjacent to and out of contact with a flat surface region of said transparent element, or disposed a predetermined distance from that flat surface region of said transparent element; and a tubular portion in which the afore-said at least one light source is accommodated, the tubular portion being defined on and along a peripheral end of the flat surface region of the transparent element.

In accordance with the present invention, there is provided a light emitter which is characterized by using the light emission device described in any one of claims 1 to 23. It is noted that other purposes, features and advantages of the present invention as well as the above-described purposes, features and advantages will become apparent more specifically by reading of the detailed description, hereinafter, with reference to the annexed drawings.

### Effects of the Present Invention

In accordance with the present invention, the transparent element has the curved surface region of substantially arcuate or circular shape in section and also has a property that allows substantive light to pass therethrough, and a light is applied from the light source to such curved surface region of transparent element. In this respect, the present invention utilizes a lens effect to the light, which is caused by that curved surface region. Accordingly, a whole of the transparent element can be illuminated uniformly with a high luminance to provide a satisfied bright illumination that fulfills desired purposes, and also, it is possible to easily alter the shape and size of the transparent element, according to requirements. Further, in the present invention, an LED(s) is/are employed as the light source, which makes it possible to reduce power consumption, and a heat radiation may be provided, as required, to suppress increase of temperature.

### BRIEF DESCRIPTION OF THE DRAWINGS

FIG. 1 illustrates an Embodiment 1 of the present invention. FIG. 1(A) is a perspective view showing an outer appearance of that first embodiment. FIG. 1(B) is an exploded perspective view of the first embodiment. FIG. 1(C) is a sectional view taken along the line #1-1 in FIG. 1(A), which shows a corresponding section of this embodiment as viewed in the arrow direction of the FIG. 1(A).

FIG. 2 provides diagrams of electric circuits for use in the foregoing Embodiment 1.

FIG. 3 illustrates an Embodiment 2 of the present invention. FIG. 3(A) is a sectional view showing a principal part of that second embodiment. FIG. 3(B) is a sectional view showing a principal part of one variant of the second embodiment. FIG. 3(C) is a perspective view of another variant of the second embodiment.

FIG. 4 illustrates an Embodiment 3 of the present invention. FIG. 4(A) is a plan view showing an outer appearance of that third embodiment. FIG. 4(B) is a sectional view taken along the line #4 -#4 in FIG. 4(A), which shows a corresponding section of this embodiment as viewed in the arrow direction of the FIG. 4(A).

FIG. 5 is a partly broken perspective view showing a structure of the foregoing Embodiment 3 from which a transparent element is removed.

FIG. 6 is a partly broken perspective view showing an Embodiment 4 of the present invention.

FIG. 7 illustrates an Embodiment 5 of the present invention. FIG. 7(A) is an exploded perspective view of that fifth embodiment. FIG. 7(B) is a sectional view taken along the line #7-#7 in FIG. 7(A), which shows a corresponding section of this embodiment as viewed in the arrow direction of the FIG. 7(A). FIG. 7(C) is a diagram showing light emission ranges attainable from emitted lights.

FIG. 8 provides a sectional view showing diameters of transparent elements used in the Embodiment 5 and a diagram showing a light emission range attainable by the transparent elements, with regard to each of two exemplary cases.

FIG. 9 illustrates an Embodiment 6 of the present invention. FIG. 9(A) is a sectional view showing a principal part of that sixth embodiment. FIG. 9(B) is an exploded perspective view of the sixth embodiment. FIG. 9(C) is a diagram showing a circuit used. FIG. 9(D) is a sectional view showing a principal part of one variant of the present embodiment.

FIG. 10 illustrates an Embodiment 7 of the present invention. FIG. 10(A) is a sectional view showing a principal part of that seventh embodiment. FIG. 10(B) is an exploded perspective view of the seventh embodiment. FIG. 10(C) is a sectional view showing one variant of the present embodiment.

FIG. 11 illustrates an Embodiment 8 of the present invention. FIG. 11(A) is a perspective view showing an outer appearance of that eighth embodiment. FIG. 11(B) is a sectional view taken along the line #11A -#11A in FIG. 11(A), which shows a corresponding section of this embodiment as viewed in the arrow direction of the FIG. 11(A). FIG. 11(C) is a plan view taken along the line #11B-#11B in FIG. 11(B), which shows arrangement of light source as viewed in the arrow direction of the FIG. 11(B). FIG. 11(D) is a diagram showing a circuit used. FIG. 11(E) is a partly broken perspective view showing one variant of the present embodiment.

FIG. 12 provides a sectional view showing an Embodiment 9 of the present invention and a sectional view showing one variant of that ninth embodiment.

FIG. 13 illustrates an Embodiment 10 of the present invention. FIGS. 13(A) and 13(B) show principal parts of that tenth embodiment. FIG. 13(C) is a perspective view of a transparent element used. FIG. 13(D) is a perspective view showing an outer appearance of one variant of the present invention.

FIG. 14 illustrates an Embodiment 11 of the present invention. FIG. 14(A) is a perspective view showing an outer appearance of that eleventh embodiment. FIG. 14(B) is a sectional view showing a principal part of the present embodiment.

FIG. 15 illustrates an Embodiment 12 of the present invention. FIG. 15(A) is a perspective view showing an outer appearance of that twelfth embodiment. FIG. 15(B) is a sectional view taken along the line #15 -#15 in FIG. 15(A), which shows a corresponding longitudinal section of this embodiment as viewed in the arrow direction of the FIG. 15(A).

### DESCRIPTION OF REFERENCE NUMERALS IN THE DRAWINGS

10: Light emission device
11: End cover
12: Light cover
14: Opening area
16: Bottom wall
18: Substrate
20A, 20B: Electrode patterns
22: LED (light-emitting diode)
24, 26: Leads
30: Transparent element
32: Power source
34: Switch
36: LED board
37: Substrate
38: LED
39A, 39B: Electrode patterns
40, 40A, 40B: Light emission devices
42: Transparent element
44: Light introduction area
50: Light cover
52: Bottom wall
54: End
56: Substrate
60: LED
62: Heat-conducting sheet
64: Heat radiation fin
66: Light scattering region
70: Light-emitting device
72: Securing plate
74: Light cover
76: Bottom wall
77: Storage space
78: Transparent element
80A, 80B: LEDs
82A, 82B: Light emission regions
84A, 84B: Markings
86, 88: Leads
89: Heat-conducting sheet
90: Light emission device
92: Light cover
94A: Bottom wall
94B : Vertical lateral wall
96: Transparent element
98, 100: Cap elements
102A, 102B: LEDs
104A, 104B: Light emission regions
106A, 106B: LEDs
110, 112: Leads
150: Light emission device
152: Light cover
153, 154: Vertical lateral walls
156: Bottom wall
158: Opening area
160, 162: Transparent element
164, 166: Illumination ranges
200, 200A: Light emission devices
202: Transparent element
203: Light scattering region
204A, 204B: Sloped surfaces
206: Bottom wall
208: Light cover
210A, 210B: Sloped surfaces
212: Groove
214: Lighting board
216: Substrate
218A, 218B: Electrode patterns
220: LED
222, 224: Leads
226: Switch
228: Power source
230, 230A: Light emission devices
232: Transparent element
234: Light scattering region
236: Light entering area
240: Light cover
242A, 242B: Curved surface region
244: Groove
300: Light emission device
312: Transparent element
314: Tubular portion
316: Light introduction area
318: Base
320: Substrate
322A, 322B: Electrode patterns
324, 326: LEDs (light-emitting diode)
324B, 326B: Markings
334, 336, 342, 344: Leads
338: Power source
339: Switch
340: Light quantity controller (variable resistance)
346: Light scattering region
350: Light emission device
352, 352A: Transparent elements
354: Tubular portion
356: Storage space
358: Light introduction area
360: Substrate
362: LED
364: Light emission region
366, 368, 379: Leads
370: Base
372: Lead port
374: Switch
376: Power source
380: Solar battery panel
384, 386: Electrode layers
388, 390, 394: Leads
392: Storage battery
396: Light scattering region
400: Light emission device
402: Transparent element
404: Recession
406: Sloped surface
408: Tubular portion
410: Shade
420: Base
450: Light emission device
452: Transparent element
454: Flat surface region
456: Tubular portion
460: Base portion
500: Baton
502: Grip
504: Main body
506: First light emission section
510: Cylindrical member
512: Transparent element
514: Light scattering region
516: Transparent window
518: LED
520: Substrate
522, 524, 546, 548, 550: Leads
526: Switch
528: Battery
530: Second light emission section
532: Transparent element
534: Tubular portion
536: Storage space
538: Light introduction area
540: Attachment
542: LED
544: Light emission region

### BEST MODE FOR CARRYING OUT THE PRESENT INVENTION

The present invention may be embodied in many various ways within the scopes of the appended claims, but, hereinafter, several exemplary modes of the invention which are deemed appropriate will now be described in details.

### Embodiment 1

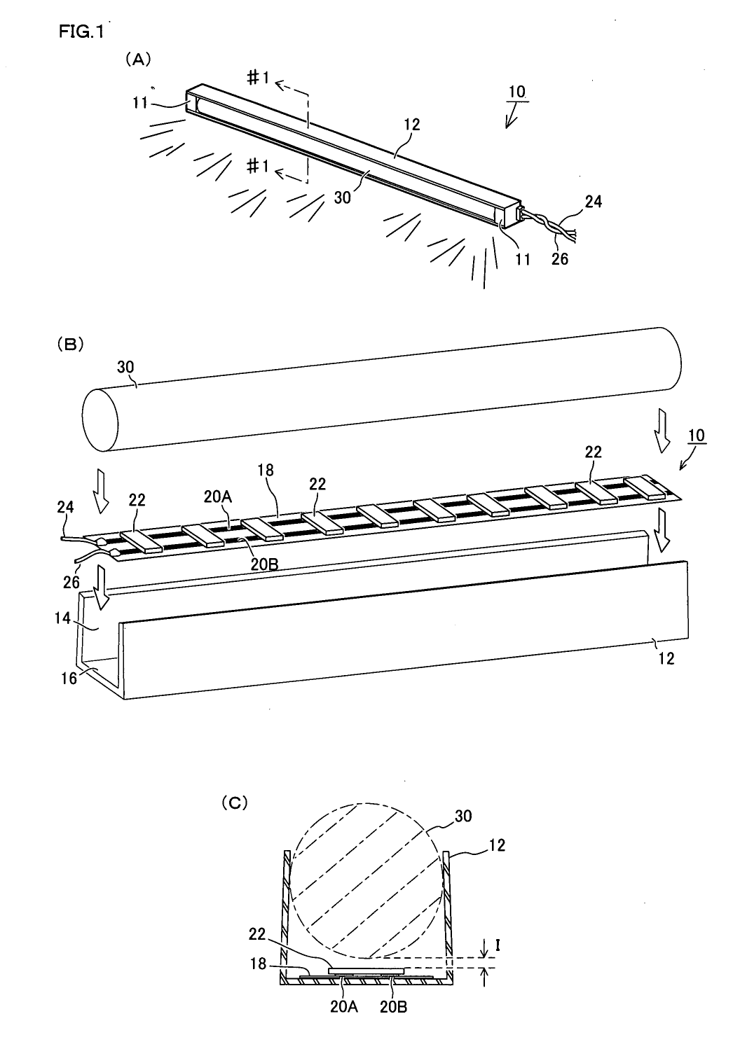

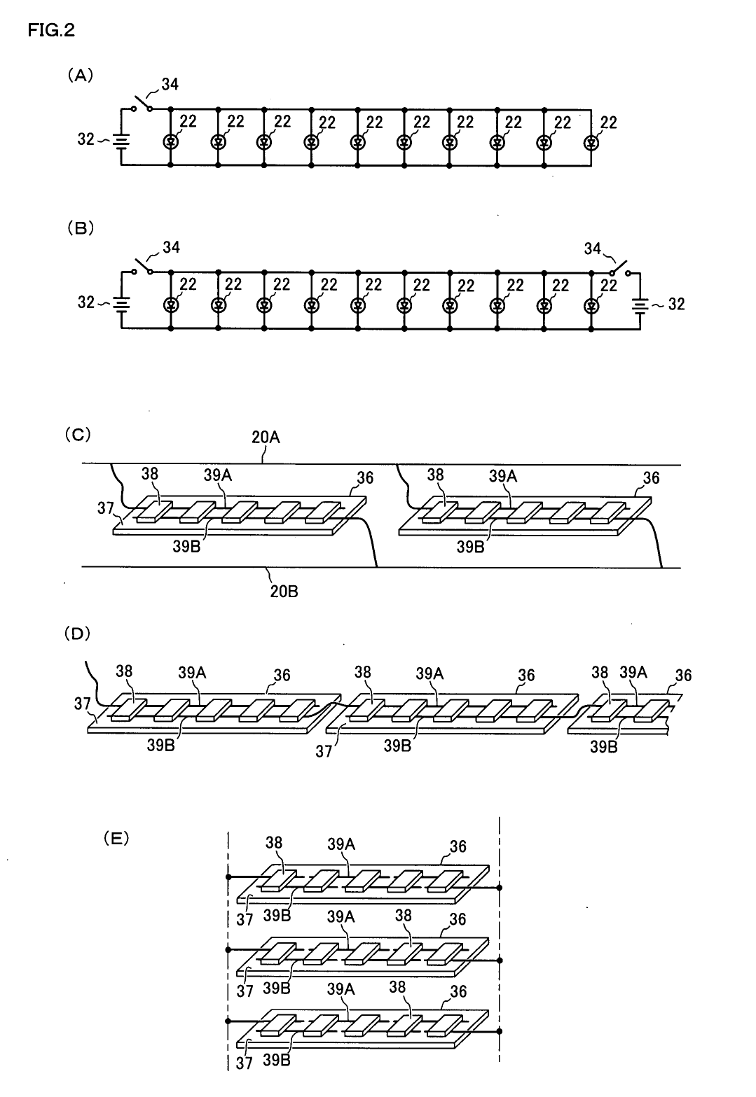

First of all, referring to FIGS. 1 and 2, a specific description will be made of a 1st embodiment of the present invention. FIG. 1(A) is a perspective view showing an outer appearance of the present embodiment of light emission device. FIG. 1(B) is an exploded schematic perspective view of the same. FIG. 1(C) is a sectional view taken along the line #1-#1 of FIG. 1(A), which shows a corresponding section of this embodiment as viewed in the arrow direction of the FIG. 1(A). FIG. 2 provides circuit diagrams in the present mode of light emission device. The present embodiment is an example applied to a linearly extending mode of lighting equipment which is adaptable for various uses and purposes. Namely, in this particular embodiment, a light emission device 10 is provided, according to which, there are provided LEDs 22, a light source, and a transparent element 30 of a columnar shape having a substantially circular shape in section, which is disposed adjacent to the LEDs 22, and those LEDs 22 and transparent element 30 are accommodated in a light cover 12 of substantially channel shape in section. As required, an end cover 11 may be attached to each of two ends of the transparent element 30. As seen in FIGS. 1(B) and 1(C), the substantially channel section of light cover 12 may be formed such that the two vertical walls thereof converge toward each other, thus making relatively narrow an upper region of an opening area 14 corresponding to two free end portions respectively of those particular two vertical walls. The light cover 12 is formed from an elastic plate material (e.g. an aluminum plate or plastic plate) for allowing the two free end portions thereof to be resiliently bendable outwardly to a certain extent by applying a pressing force thereto, thereby making it possible to widen the upper region of the opening area 14.

A flexible substrate 18, substantially identical in shape to the bottom wall 16 of the light cover 12, is provided, and, formed on that flexible substrate 18 are a pair of electrode patterns 20A and 20B which extend in parallel with each other. A plurality of the afore-said LEDs 22 are disposed on the flexible substrate 18 in such a manner as to extend transversely of the latter and bridge over the two electrode patters 20A and 20B. Two different leads 24 and 26 are electrically connected with the respective two terminals of those two electrode patterns 20A and 20B. Each of such electrode patterns 20A and 20B may be formed from copper for example and has been printed on the substrate 18. A desired number of the LEDs 22 may be provided on the electrode patterns 20A, 20B. In the illustrated embodiment, ten pieces of LEDs 22 are disposed equidistantly on the substrate for electrical connection between the two electrode patterns 20A and 20B. The aforementioned transparent element 30 is substantially equal in length to or slightly shorter than the light cover 12, and has a diameter substantially equal to a width of the bottom wall 16 of the light cover 12. For instance, the transparent element 30 may be formed from acrylic material into the illustrated shape of columnar rod which is transparent and has a property that allows substantive light to pass therethrough. The diameter of that columnar transparent element 30 is approx. 5 mm-20 mm, for example.

More specifically, the LEDs 22 are arranged on the substrate 18 so as to bridge over the two electrode patterns 20A and 20B extending on and along the substrate 18 in parallel with each other, with a pair of terminals (not shown) of each of the LEDs 22 electrically connected with the respective two electrode patterns 20A and 20B. The two leads 24 and 26 are electrically connected with the respective two terminals of the two electrode patterns 20A, 20B by a suitable means. Then, the thus-formed substrate 18 with the LEDs 22 mounted thereon is firmly attached on the bottom wall 16 of the light cover 12. Thereafter, the transparent element 30 is brought to a point above so assembled light cover 12 and forcibly inserted in the two vertical walls of the light cover 12, to the extent that the transparent element 30 per se is retained in the opening area 14, with a predetermined space I given between an outer surface of each LED 22 and that particular transparent element 30. Such space I may be approx. 1.5 mm-2.0 mm, for instance. Under that state, the two vertical walls of light casing are resiliently bent outwardly by the transparent element 30 to widen the corresponding region of the opening area 14, since the diameter of the transparent element 30 is slightly larger than the width of that corresponding region of opening area 14 as understandable from the description above. Consequently, the two vertical walls of the light cover 12 effort to bend inwardly of the light cover 12 due to the resilient recovery force thereof, thereby securely retaining the transparent element 30 in place within the light cover 12.

As stated above, one lead 24 and another lead 26 are electrically connected with the LEDs 22. As seen from FIG. 2(A), such one lead 24 further has an electrical connection with one terminal of the power source 32 provided exteriorly of the light cover 12, whereas on the other hand, the said another lead 26 further has an electrical connection with another terminal of the power source 32 via a switch 34. Thus, established is a circuitry wherein the ten LEDs 22, connected with one another in parallel, are electrically connected with the power source 32 via the switch 34, so that turning on and off the switch 34 results in the LEDs 22 lighting on and going out, respectively. Or, alternatively, a ringed or annular circuitry may be arranged by directly connecting the two terminals of one electrode pattern 20A with the respective two terminals. of another electrode pattern 20B and by disposing the LEDs 22 on those two electrode patterns 20A, 20B , while electrically incorporating the power sources 32 and switch 34 in that annular circuitry. One example of such arrangement is shown in FIG. 2(B). With reference to that FIG. 2(B), it is seen that one set of the power source 32 and switch 34 and another set of the power source 32 and switch 34 are arranged on the opposite sides of one array of the LEDs 22 connected together in parallel, and it is to be noted here that the two power sources 32 used are identical to each other, and so are the two switches 34 used.

Instead of the foregoing single circuitry where each of the LEDs 22 is merely incorporated for parallel connection over the electrode patterns, it may be arranged, as seen in FIG. 2(C), such that there are provided a plurality of LED boards 36, each having a plurality of LEDs 38 (or five LEDs 38 as shown) disposed thereon in such a manner that each of the LEDs 38 bridges over the two electrodes 39A and 39B for electrical connection therebetween, and that those plurality of LED boards 36 are electrically connected with one another in parallel. Alternatively, as shown in FIG. 2(D), a plurality of another LED boards 36 may be provided, each of which has a plurality of LEDs 38 disposed thereon in such a manner that each of the LEDs 38 bridges over the two electrodes 39A and 39B for electrical connection therebetween. In this particular alternative mode, a series connection is adopted among the LED boards 36, such that one of the two electrode patterns (the electrode pattern 39B, for example) associated with one LED board 36 is electrically connected with another of the two electrode patterns (the electrode pattern 39A for example) associated with adjacent another LED board 36, and, likewise, all other LED boards 36 may be connected with other another in series. Both of those two alternative modes are effective against the case where a luminance is decreased due to some of the LEDs 38 being gone out. Namely, even if some of the LEDs 38 in at least one of the boards 36 happen to go out due to trouble, other LEDs 38 in all other remaining operative boards 36 continue to emit light therefrom, thereby compensating for the decreased luminance in that particular case so as to keep a certain bright illumination. As still another alternative mode, referring to FIG. 2(E), it may be so arranged that the two electrode patterns 39A and 39B are alternately cut off at the interval of one LED 38, with respect to one LED board 36, so that, upon one LED board 36, all the LEDs 38 are electrically connected together in series via so alternately cut arrangement of electrode patterns. Of course, a plurality of such LED boards 36 be electrically connected together in parallel, as indicated by the one-dot chain lines.

Next, a specific description will be made of operation of the above-described embodiments. As shown in FIG. 1, the light emission device 10 may be installed at a given location, with the opening area 4 thereof facing to a side or an object to be illuminated thereby. Or, instead of such fixed installation, the light emission device 10 may be arranged in a movable manner. Upon turning on the switch 34, a current is applied from the power source 32 to the LEDs 22 provided in the light cover 12, and the LEDs 22 emits light therefrom in a direction to the transparent element 30. At this moment, since an air zone is provided in a space between the transparent element 30 and the LEDs 22, a plurality of lights emitted from the LEDs 22 expand freely in that air zone and are therefore applied to the transparent element 30 from many angles. Then, the lights passing through the transparent element 30 are refracted and dispersed due to a lens effect caused by the substantially circular section of transparent element 30, and then emitted outwardly from the opening area 14 of the light cover 12. In this regard, an emission range of the lights, or how widely the lights on the whole are emitted outwardly , may be determined by a configuration of the opening area 14. When the above-described light emitting state of light emission device 10 is viewed from the outside, it is observed that the transparent element 30 is illuminated uniformly along the lengthwise direction thereof, with a high luminance, as if such illumination created a band of light in the eyes of a person looking thereat.

Accordingly, the present Embodiment 1 has the following effects and advantages:

(1) The light cover 12 is attached to and along the outer surface of the long transparent element 30, such that a plurality of the LEDs 22, a light source, are disposed inside of and lengthwise of the light cover 12, with the predetermined space I given between the outer surface of transparent element 30 and that particular light cover 12, and that lights are to be applied from the LEDs 22 to the transparent element 30. By virtue of such arrangement, an air zone is defined between the transparent element 30 and the LEDs 22, and the transparent element 30 serves as a lens, to thereby cause the lights from the LEDs to diffuse as stated above, whereby a whole longitudinal body of the transparent element 30 is illuminated uniformly, with a high luminance sufficient to meet requirements for practical uses and serve any required purposes.

(2) The LEDs 22 are employed as a light source, which realizes a reduced power consumption, while maintaining a high lighting efficiency, thus allowing for reduction of running costs involved. Further, it is possible to keep a temperature at a lower degree in comparison with incandescent lamp or fluorescent lamp.

(3) The switch(s) 34 is/are provided. Thus, when lighting is not required, the switch(s) 34 is/are turned off to cease emission of light from the LEDs 22, hence eliminating unnecessary waste of illumination by the light emission device.

### Embodiment 2

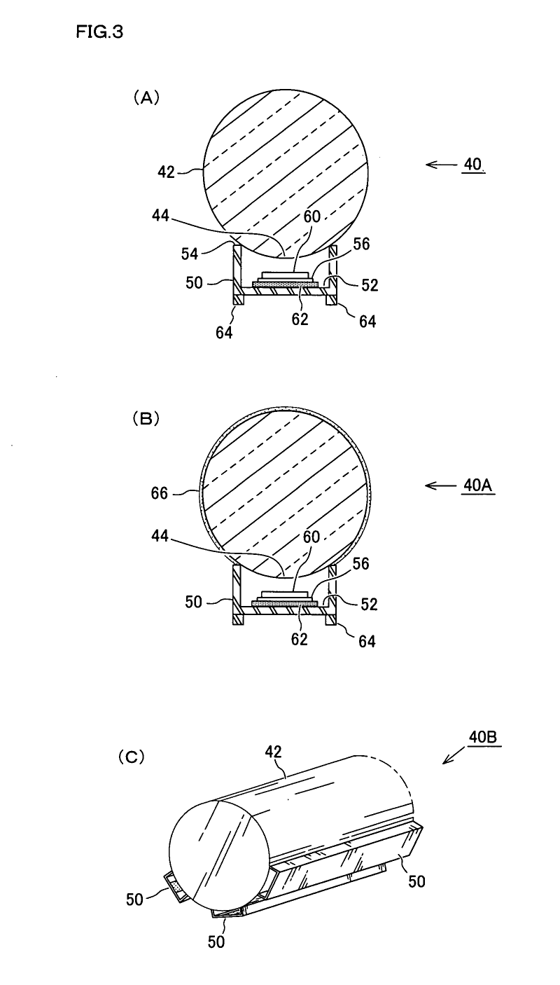

Reference being made to FIG. 3, a specific description will now be made of a 2nd embodiment of the present invention. FIG. 3(A) is a sectional view showing a principal part of the present embodiment. FIG. 3(B) is a sectional view showing a principal part of modified mode of the present embodiment. FIG. 3(C) is a perspective view showing another modified mode of the present embodiment. As similar to the previously described Embodiment 1, the present embodiment also employs a long columnar transparent element, but its purpose is to effectively suppress an increase of temperature or to keep the temperature to a low degree, by positively causing radiation of heat. At first, referring to FIG. 3(A), a light emission device 40 is provided, which comprises: a plurality of LEDs 60 as a light source; and a substrate 56 on which the LEDs are mounted, such that those LEDs 60 and substrate 56 are accommodated in a light cover 50 of substantially channel shape in section. The light cover 50 has two vertical walls, each having an edge 54 in the upper end thereof. According to this embodiment, the columnar transparent element 42 of substantially circular shape in section is mounted on the light cover 50, with the outer circumferential surface of that transparent element 42 being in contact with the edges 54 of the light cover 50. It is to be noted that electrode patterns on the substrate 56 and the LEDs 60 thereon are arranged in the same manner as previously described in the foregoing Embodiment 1. But, in the Embodiment 1, a small local area of the transparent element, which is smaller than a half of the whole transparent element, is exposed from the light cover. By contrast, the present Embodiment 2 is of the arrangement that a substantive or great area of the transparent element 42 is exposed from the light cover 50, and the light cover 50 itself is formed from a material of a high heat radiation property, such as aluminum plate material.

Further, according to this particular embodiment, a heat-conducting sheet 62 having a heat conductive property is interposed between the bottom wall 52 of the light cover 50 and the substrate 56 on which the LEDs 60 are disposed. The heat-conducting sheet 62 may be a sheet of graphite material, but, any other known sheet having a proper heat conductive property be used. In addition thereto, a plurality of heat irradiation fins 64 are provided to an outer surface of the bottom wall 52 of the light cover 50.

Basically, the present mode of light emission device emits light in the same way as the previously described Embodiment 1, but, the advantage thereof is that a heat generated from the operative LEDs 60 is imparted through the substrate 56 to the heat-conducting sheet 62 which in turn conducts and transmits the heat to the light cover 50 that has a heat radiation property, and that the thus-transmitted heat is radiated outwardly from the light cover 50, while at the same time, such radiation of the heat is further promoted by the heat radiation fins 64. Thus, according to the present second embodiment, it is possible to properly suppress increase of temperature in the light emission device, in addition to the previously described effects and advantages of the Embodiment 1.

Now, a description will be made of two variants of the present second embodiment. At first, reference is made to FIG. 3(B) showing one variant of light emission device, as designated by 40A, which includes a transparent element 42 having, defined in the surface thereof, a light scattering region 66 which is frosted, and a light introduction area 44. As shown, the light scattering region 66 is defined on a surface portion of the transparent element 42 which is exposed outwardly from the light cover 50 so as to allow light to emit outwardly therefrom, whereas the light introduction area 44 is defined in another opposite surface region of the transparent element 42 that faces inwardly of the light cover 50. The light introduction area 44 is only transparent. In this respect, the afore-said light scattering region 66 may be a film effective in causing light to reflect diffusely therefrom, the film being for example formed by evaporating or applying a coating material to the corresponding surface region of the transparent element 42, wherein the coating material contains a suitable white pigment. Hence, according to the present mode, lights emitted from the LEDs 60 are first refracted and diffused due to the lens effect of transparent element 42 and then advance radially toward the frosted light scattering region 66. At this moment, the lights passing through the frosted layer of light scattering region 66 are efficiently scattered (or reflected diffusely) in many directions. Accordingly, this particular mode insures to achieve a highly enhanced uniformity of light being emitted outwardly.

FIG. 3(C) illustrates another variant of the second embodiment, in which a light emission device 40B is provided. This light emission device 40B has a transparent element 42 and is provided with three pieces of the afore-said light covers 50, such that those three light covers 50 are securely disposed at respective three given locations upon the outer surface of the transparent element 42. This arrangement is effective in highly increasing luminance of light emitted from the device. Of course, likewise as in the mode shown in FIG. 3(B), the exposed surface regions of the transparent element 42, which is not covered with the three light covers 50, may be treated so as to provide a frosted light scattering region.

### Embodiment 3

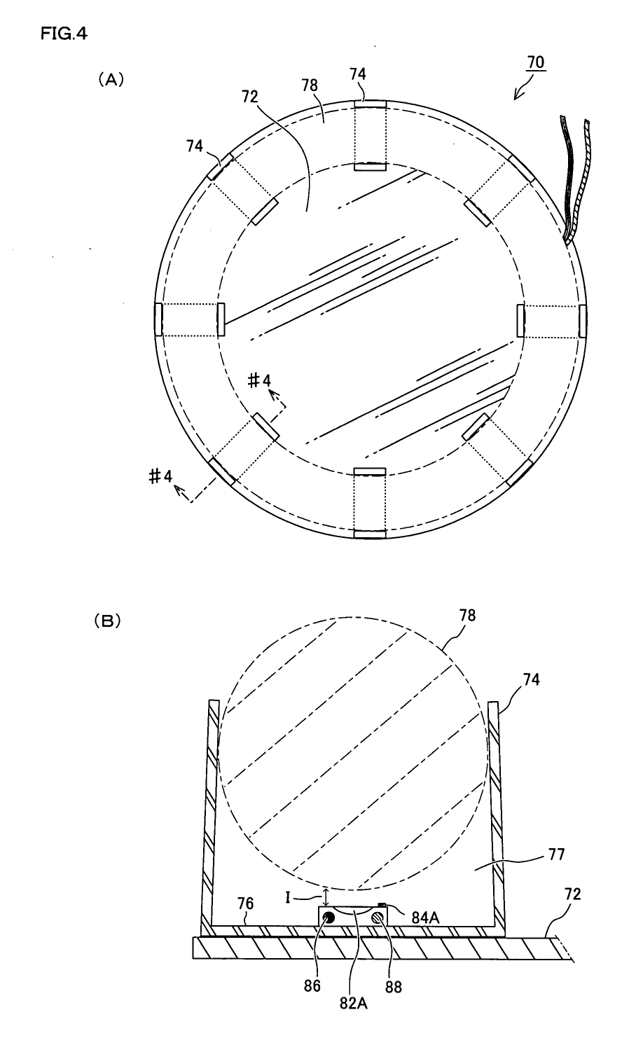

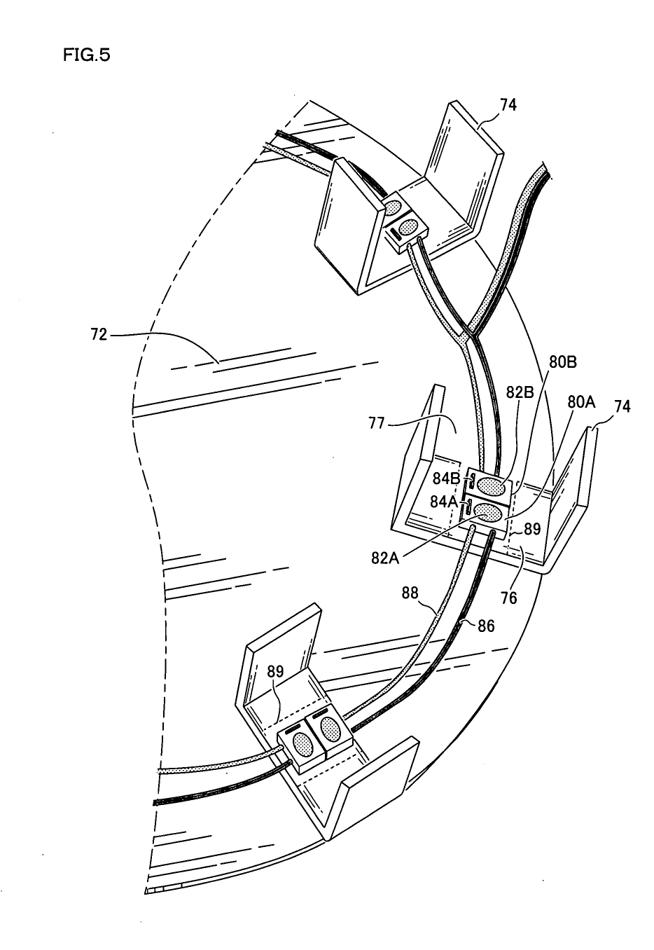

Reference being now made to FIGS. 4 and 5, a description will be made of the 3rd embodiment of the present invention. While the above-described Embodiments 1 and 2 utilize a rectilinear configuration of transparent element, the present third embodiment is directed to a light emission device having a ring configuration of transparent element. FIG. 4(A) is a plan view showing an outer appearance of light emission device of the present embodiment. FIG. 4(B) is a sectional view taken along the line #4-#4 in FIG. 4(A), which shows a corresponding section as viewed in the arrow direction of the FIG. 4(A). FIG. 5 is a perspective view showing the state where a transparent element is removed form the light emission device of the present embodiment.

A light emission device 70 in this third embodiment is provided as a ring (or annular) shape of lighting equipment that can be installed at a given location, and comprises: a transparent element 78 having a property that allows substantive light to pass therethrough; a securing plate 72 provided behind the transparent element 78; a plurality of light covers (or a plurality of retainer elements) 74 for embracingly retaining the transparent element 78 in such a manner as to sandwich two opposite outer surface areas of the latter 78, wherein those light covers 74 are fixedly attached on the securing plate 72; and a pair of LEDs 80A and 80B provided inside of each of the light covers 74, the pair of LEDs 80A and 80B being a light source for emitting and applying light to the transparent element 78. As shown in FIG. 4(B), the transparent element 78 is so formed to have a substantially circular shape in section, using an acrylic resin material as similar to the previously described embodiments, wherein the acrylic resin material is transparent and has a property that allows substantive light to pass therethrough. The securing plate 72 may be formed from a stainless or aluminum material, for instance, into the illustrated disc shape which is slightly larger than the outer ring contour of the transparent element 78. But, the securing plate 72 itself is not necessarily used, but may be provided as required.

Each light cover 74 is of a substantially channel shape in section. The above-described pair of LEDs 80A and 80B are securely attached on a bottom wall 76 of that light cover 74. Further, defined among the bottom wall 76 and two vertical walls of the light cover 74 is a storage space 77 in which the transparent element 78 is supportively received and retained by being securely sandwiched partway between the two vertical walls of the light cover 74. Namely, the light cover 74 acts to securely retain therebetween the two opposite local outer surfaces of the transparent element 78. The light cover 74 per se may be formed from a stainless or aluminum material, for example. As far as the illustrative present embodiment is concerned, eight equidistant light covers 74 are fixedly arranged on the peripheral end portion of the securing plate 72. But, this is not imitative, and the number of the light covers 74 may be increased or decreased appropriately, as required, to the extent of sufficiently retaining the transparent element 78. It is noted that a suitable connecting means may be provided to a reverse surface of the securing plate 72 and the present light emission device 70 be securely attached by that connecting means to a desired location, thereby allowing its use as an appropriate lighting equipment.

Each of the foregoing LEDs 80A and 80B, provided on the bottom wall 76 of the light cover, is of an oblong shape. It is seen that a pair of such LEDs 80A and 80B are securely disposed abreast upon that bottom wall 76. Those two LEDs 80A and 80B are respectively provided with light emission regions 82A and 82B in the respective upper surfaces thereof. It is noted here that each of those LEDs is not of a molded-resin type and therefore any resin layer does not cover each of the light emission regions 82A and 82B. Further, the two LEDs 80A and 80B are provided with the respective polar markings 84A and 84B each being indicative of a certain pole associated with an electrode corresponding to one of the two LEDs 80A and 80B. In this respect, let us now assume, for example, that a terminal provided on the reverse side of each of the two LEDs is an “anode”, which corresponds to each of the two polar markings 84A and 84B. Also, let us assume that such arrangement of anode markings 84A and 84B is applied to all another pairs of LEDs 84A and 80B provided in the respective another light covers 74, and further, all those anode markings 84A and 84B are disposed inwardly of the circularly arranged light covers 74 so as to face toward a center of the securing plate 72. In that case, it may be so arranged that all the anode terminals of the LEDs 84A and 80B are electrically connected with one lead 88, while on the other hand, all cathode terminals, disposed opposite to such anode terminals in those particular LEDs, are electrically connected with another lead 86. While not shown, those leads 86 and 88 may be connected to a power source, and also, a switch be provided, such that turning on and off the switch causes supply and disconnection of current to the leads.

In the present embodiment, as similar to the previously described Embodiment 2, a heat-conducting sheet 89, as indicated by dotted line in FIG. 5, may be provided between the LEDs 80A and 80B and the bottom wall 76 of the light cover 74, and further, the securing plate 72 be formed from a material of high heat radiation property, such as aluminum material, in order that a heat generated from the LEDs 80A and 80B is radiated through the light cover 74 as well as from the securing plate 72.

The transparent element 78 is installed in the foregoing heat radiation structure of light cover 74, with a predetermined space I given between the light cover 74 and the transparent element 78, so as to avoid contact of the outer surface of the transparent element 78 with the light emission regions 82A and 82B respectively of the LEDs 80A and 80B. As an example of such installation of transparent element 78, the light cover 74 may be formed such that an inwardly biasing force is provided to the two vertical walls thereof, so that the transparent element 78 can be securely retained by and in the light cover 74, due to such biasing force, to thereby give the space for avoiding contact between the transparent element 78 and the LEDs 80A and 80B. Or, alternatively, the light cover 74 be provided with inwardly projected pieces inside thereof, so that the transparent element 78 can be retained by such projected pieces to give the space for avoiding contact between the transparent element 78 and the LEDs 80A and 80B. Preferably, the space I may be 1.5 mm-2.0 mm, for instance. But, the space I may be varied appropriately in consideration of a dimensions of the light emission device 70, a diameter of the transparent element 78, and so forth.

A description will now be made of operation of the present third embodiment. At first, though not shown, upon a switch being turned on, a current is supplied from a power source to the light emission device, thereby causing the LEDs 80A and 80B to light on. Then, lights emitted from the LEDs 80A and 80B are applied to the transparent element 78. At this moment, since an air zone lies between the transparent element 78 and the light emission regions 82A and 82B, the lights are dispersed in the air zone, before advancing into the inside of the transparent element 78. Further, because of no coating on the light emission regions 82A and 82B, original lights emitted therefrom expand freely in the afore-said air zone and are therefore applied to the transparent element 78 from many angles, as opposed to lights emitted from resin-coated light emission regions of molded-resin type of LEDs. Hence, the lights entering the transparent element 78 are reflected within that particular transparent element 78 and then emitted outwardly from the outer surface of the transparent element 78. At this moment, however, it is to be seen that, due to the substantially circular section of transparent element 78 serving as a lens in the curved surface thereof, the lights are naturally refracted and dispersed thereat, prior to outward emission thereof, and therefore, such refracted and dispersed lights are emitted from the transparent element 78 to the outside.

Accordingly, in the present Embodiment 3, it is appreciated that the above-discussed lens effect due to the sectional shape of transparent element 78 is indeed achieved by this particular ring configuration of transparent element 78 to attain an increased luminance. Moreover, the present embodiment emits light outwardly from much wider angles than the previously described Embodiments 1 and 2, which is quite suited for wide light emission purposes. In addition thereto, the surface of the securing plate 72 may be treated with a material of high reflective property, in which case, some portions of the lights, applied from the transparent element 78 to that securing plate 72, will be reflected towards a side or object to be illuminated by the present light emission device, thereby permitting use of a full or substantive amount of lights emitted from the LEDs 80A and 80B and directing a whole of such lights towards the side or object to be illuminated.

### Embodiment 4

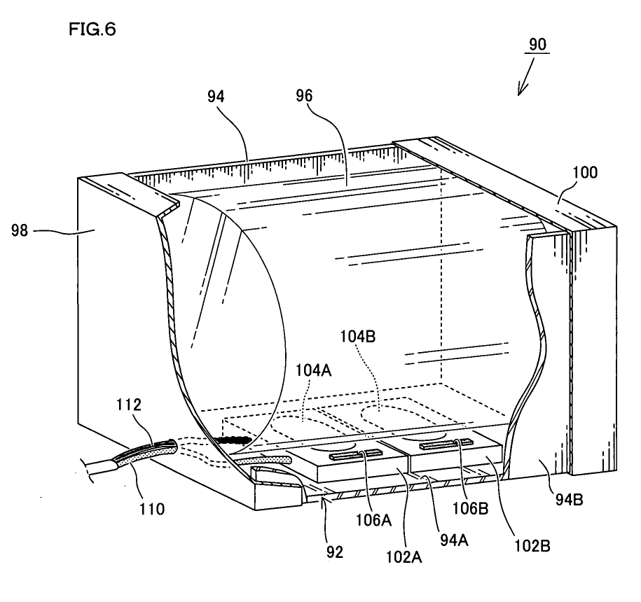

Reference is now made to FIG. 6, and a description will be made of a 4th embodiment of the present invention. While the previously described Embodiments 1 and 2 utilize a rectilinear long configuration of transparent element, the present embodiment is directed to a light emission device employing a short transparent element. Namely, in this particular embodiment, a light emission device 90 is provided, which comprises: a light cover 92 of substantially channel shape in section; one set of LEDs 102A and 102B provided on the bottom wall 94A of the light cover 92; and a transparent element 96 securely retained between two vertical lateral walls 94B of the light cover 92. A pair of cap elements 98 and 100 are attached to the respective two ends of the transparent element 96.

The afore-said LEDs 102A and 102B have, defined in the respective upper surfaces thereof, a pair of light emission region 104A and marking 106A and a pair of light emission region 104B and marking 106B. Likewise as in the foregoing Embodiment 3, the markings 106A and 106B indicate certain poles associated with electrodes respectively of the LEDs 102A and 102B. For example, those two markings 106A, 106B may each be affixed on a side of the corresponding LED 102A or 102B wherein an anode is provided. While not shown, each of the LEDs 102A and 102B has, provided therein, two terminals which are respectively associated with anode and cathode, and those two terminals are in turn electrically connected with two different leads 110 and 112, respectively. As shown, both of such two leads 110 and 112 extend through the cap element 98 to the outside. With this arrangement, in brief, the markings 106A and 106B may be affixed on the respective two LEDs 102A and 102B to indicate anodes or cathodes for the corresponding two terminals respectively of those particular two LEDs, and a current may be appropriately applied through the two leads 110 and 112 to the LEDs 102A and 102B. As similar to the previously described embodiments, in order to avoid its contact with the LEDs 102A, 102B, the transparent element 96 may be secured in the light cover, with a predetermined space being given between the one set of LEDs 102A, 102B and the transparent element 96 itself. Also, the light cover 92 be formed from a material having heat radiation property, and a heat-conducting sheet (not shown) be provided between the light cover 92 and the said one set of LEDs 102A, 102B, with a view to radiating a heat generated from those particular LEDs. It is to be appreciated that, while being basically similar to the Embodiment 1 in terms of operation and effects, the present fourth embodiment is suited for use as a relatively small size of lighting equipment, such as an interior lamp for use in an automobile.

### Embodiment 5

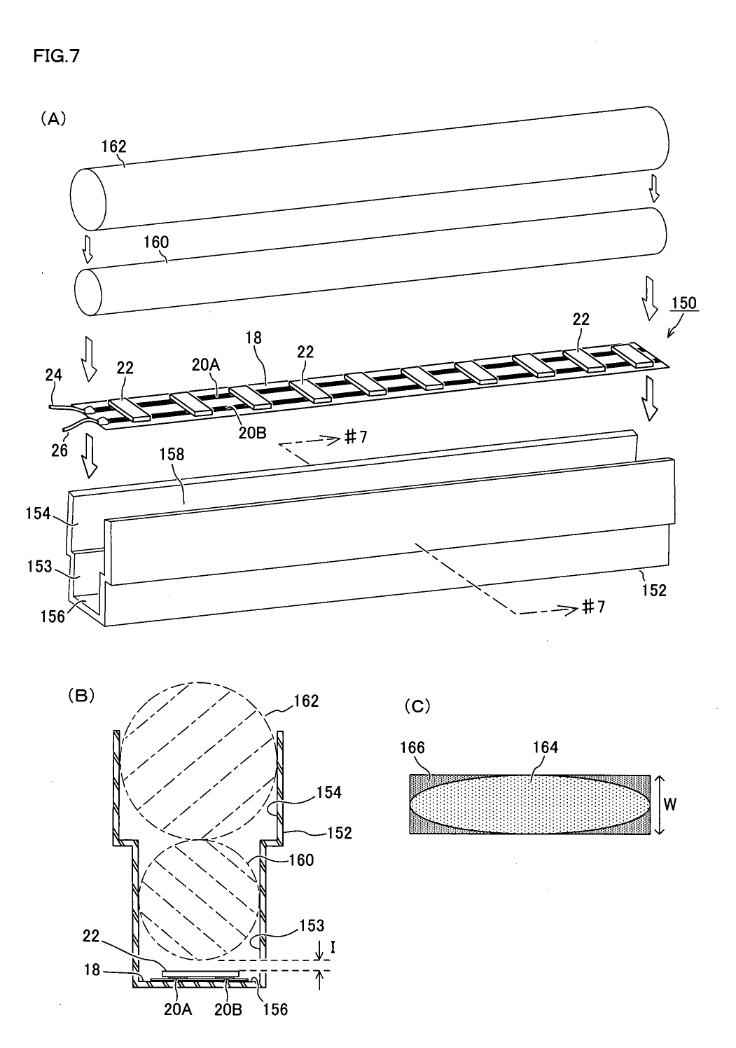

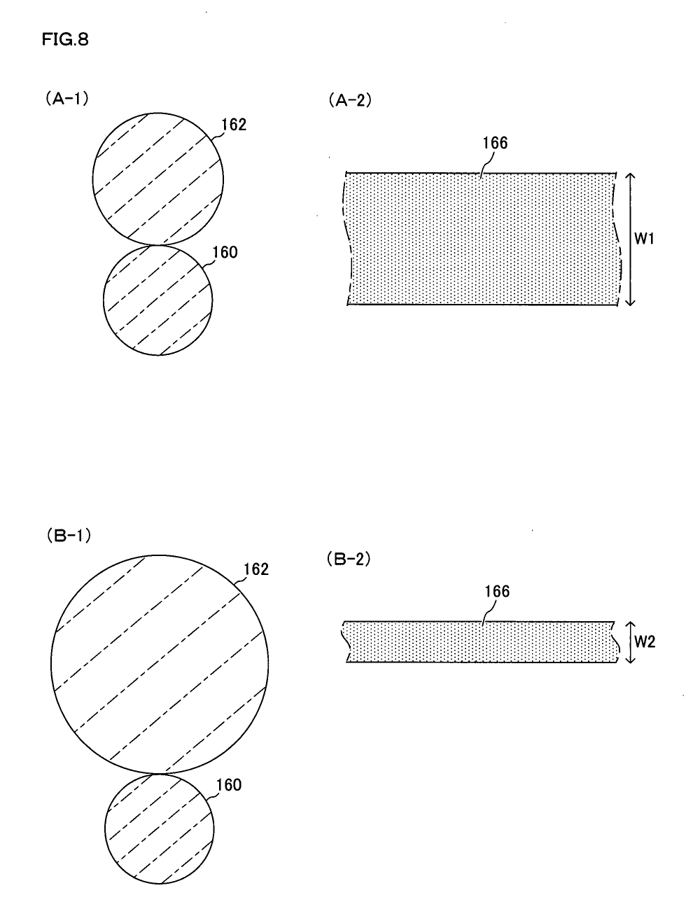

Reference being made to FIGS. 7 and 8, a 5th embodiment of the present invention will be described. Since this particular embodiment is partly similar to the previously described Embodiment 1, it is to be noted that all like designations in the Embodiment 1 correspond to all like designations to be used hereinafter. FIG. 7(A) is an exploded perspective view showing principal parts of the present embodiment. FIG. 7(B) is a sectional view taken along the line #7 -#7 in FIG. 7(A), which shows a corresponding section of the embodiment as viewed in the arrow directions of the FIG. 7(A), and indicates the state where the principal parts have been assemble together. FIG. 7(C) is a diagram for showing a light emission range attainable by the present embodiment. Likewise as in the previously described Embodiments 1 and 2, a rectilinear long columnar configuration of transparent element is employed, but, in the present embodiment, a pair of such rectilinear long columnar transparent elements are provided to permit for adjusting and widening a range of light emission. Namely, as shown in FIG. 7(A), there is provided a light emission device 150 which includes a light cover 152 of stepped configuration having two stepped lateral walls. According to the light emission device 150, accommodated in such light cover 152 are: a substrate 18 on which a plurality of LEDs 22, as a light source, are mounted; one columnar transparent element 160 which is disposed in a close proximity to the LEDs 22, while being retained out of contact with the latter 22; and another columnar transparent element 162 which overlies and contacts the afore-said one columnar transparent element 160. The stepped configuration of light cover 152 is preset appropriately, such that the lower region thereof is so dimensioned as to securely retain the afore-said one columnar transparent element 160 therein, whereas the upper region thereof is so dimensioned as to securely retain the afore-said another columnar transparent element 162 therein. Such light cover 152 is, for example, formed from an aluminum material by a drawing process into the illustrative stepped configuration. Likewise as in the previously described Embodiment 1, the plurality of LEDs 22 are disposed on and along the substrate 18, and that particular substrate 18 is fixedly mounted on the bottom wall 156 of light cover 152. Note that all the LEDs 22 and electrode patterns 20A, 20B are electrically arranged in the same manner as the Embodiment 1.

In the illustrative exemplary embodiment, the light cover 152 has: a pair of lower vertical lateral walls 153; and a pair of upper vertical walls 154, each being elastic so as to serve as two leaf springs. Thus, the afore-said one transparent element 160 is securely retained between the two lower vertical walls 153, whereas the afore-said another transparent element 162 is securely retained between the two elastic upper vertical walls 154. Both of those two transparent elements 160 and 162 commonly assume a substantially circular shape in section. According to the shown embodiment, it is seen that a diameter of the transparent element 160 disposed near to the LEDs 22 is smaller than a diameter of the transparent element 162 disposed at an opening area 158 of the light cover 152. In this regard, by way of one example, suppose that the transparent element 160 is 5 mm in diameter, a proper relative diameter of the outwardly disposed transparent element 162 may be approx. 7 mm to 10 mm.

As discussed in the previously described Embodiment 1, one long configuration of transparent element is used to effectively enable formation of a band of light from lights emitted thereto. In the present embodiment, it is to be seen that two transparent elements of such long configuration are used, thereby expanding lights more widely and uniformly along the longitudinal direction thereof to create a neatly uniform band of light. For example, experiments show that, in the case of only one transparent element 160 being used, a light emission range attained thereby is indicated by the region 164 in FIG. 7(C), which means that a band of light created therefrom assumes such a configuration wherein both two end regions thereof become narrower in width as they proceed to the respective two lateral ends thereof, whereas in contrast thereto, in the present embodiment, another transparent element 162 is used in combination with the afore-said transparent element 160. Such present embodiment has the effect that the lights, which are emitted from the LEDs 22 and transmitted through the adjacent transparent element 160, further pass through the second transparent element 162, so that the lights are diffused more widely, thereby making wider an outward emission range of the lights. Consequently, as indicated in the full light emission region 166 in FIG. 7(C), a uniform band of light can be formed, which has a substantially uniform width W of light extending to both two lateral ends thereof.

The aforementioned width W of band of light may be adjustably changed by altering the diameter of the transparent element 162. Reference is now made to FIG. 8 which provides sectional and plan views for each of two exemplary variants of the present embodiment in terms of diameters respectively of the transparent elements 160, 162 as well as of light emission ranges attained thereby. Specifically stated, at first, let us arrange the two transparent elements 160, 162 as indicated in FIG. 8(A-1), such that a diameter of the transparent element 160 is 5 mm, whereas a diameter of the transparent element 162 is 6 mm. In that case, a band of light created by such arrangement is of a width W1, as shown in FIG. 8(A-2). On the other hand, let the two transparent elements 160, 162 be arranged as indicated in FIG. 8(B-1), such that the diameter of transparent element 160 remains to be 5 mm, whereas the diameter of transparent element 162 is 10 mm. Then, a band of light created thereby becomes narrow to have a width W2 smaller than the afore-said width W1, as shown in FIG. 8(B-2). The reason for such varied width of band of light is considered due to the fact that, if the transparent element 162 is slightly large in diameter relative to the transparent element 160, the former 162 optically acts to disperse lights entering thereinto from the latter 160, whereas on the other hand, if the diameter of transparent element 162 is more than twice as large as that of the transparent element 160, then the former 162 optically acts to converse lights entering thereinto from the latter 160.

Accordingly, while being basically similar to the Embodiment 1 in terms of light emission, the present embodiment provides two transparent elements 160 and 162 in the light cover 152, such that the transparent element 162 disposed on the side where lights are to be emitted outwardly therefrom is set to be large in diameter relative to the other transparent element 160 disposed on the side adjacent to the LEDs 22, thereby making it possible to cause the lights emitted therefrom to form a uniform band of light having a given width W, which extends along the entire longitudinal direction thereof. Thus, the present mode of light emission device is suited for use with various kinds of testing devices and the like. Of course, likewise as in the previously described Embodiment 2, a heat-conducting sheet may be provided between the substrate 18 and the bottom wall 156 of light casing 152, and a heat radiation fin(s) be provided to the outer surface of the light cover 152, so as to efficiently radiate a heat outwardly of the light cover 152.

### Embodiment 6

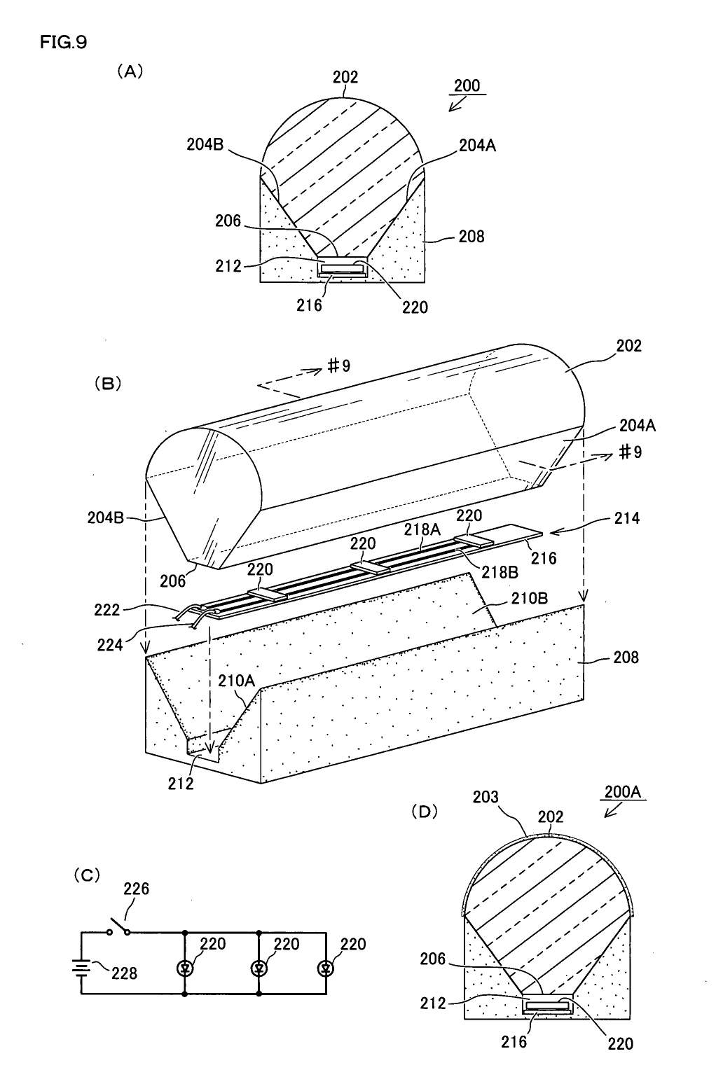

Reference being made to FIG. 9, the 6th embodiment of the present invention will be described. While all of the previously described Embodiments 1 to 5 are drawn to a substantially circular section of transparent element, the present Embodiment 6 is an exemplary mode of light emitting device employing a long transparent element having a surface region of substantially arcuate shape in section. FIG. 9(A) is a sectional view showing a principal part of the present mode of light emission device. FIG. 9(B) is an exploded perspective view illustrating a structure of the present mode of light emitting device. FIG. 9(C) is a circuit diagram. FIG. 9(D) is a sectional view showing a principal part of another alternative variant of the present embodiment. It is noted that the sectional part taken along the line #9-#9 in FIG. 9(B) as viewed from the arrow directions corresponds to the sectional illustration in FIG. 9(A). According to the present embodiment, a light emission device 200 is provided, which comprises: a transparent element 202 having a property that allows substantive light to pass therethrough; a light cover 208 which also serves to scatter lights thereon, wherein the entire surfaces of that light cover 208 are processed by a suitable surface treatment to have a certain diffusive property; and a lighting board 214 interposed between the transparent element 202 and the light cover 208.

Generically stated, the afore-said transparent element 202 is of a lengthy configuration having a substantially sector shape in section, which is so designed to cause lights to emit outwardly through the substantially arcuate region thereof. For example, the transparent element 202 may be formed from a transparent acrylic resin material into the illustrated configuration by a suitable foaming process, such as a drawing process. On the other hand, genetically stated, the light cover 208 is so configured as to only cover a given surface portion of the transparent element 202, excluding the arcuate surface portion of the same 202 from which lights are to be emitted outwardly. More specifically, the light cover 208 is so formed to have: a valley region which defines a pair of sloped surfaces 210A and 210B; and a groove 212 adapted for receiving the afore-said lighting board 214 therein, said groove 212 being defined in the bottom of such valley region so as to extend along the longitudinal direction of the light cover. This light cover 208 may be formed from a resin or glass material, for example, by a suitable forming process, into the illustrated configuration. Further, in processing the surfaces of the thus-formed light cover 208, the afore-stated frosted surface treatment may employ a sheet of light scattering property or the like, and such particular sheet be fixed on the surfaces of the light cover 208. As shown, the transparent element 202 is securely received in the valley region of the light cover 208, such that a pair of sloped surfaces 204A and 204B thereof are in close contact upon the respective pair of sloped surfaces 210A and 210B of the light cover 208. It is noted here that the groove 212 is preformed to have a predetermined depth so as to give a space between the lighting board 214 and the bottom surface 206 of the transparent element 202, thereby preventing any contact between those two elements 214 and 202. It is also noted that a length of the transparent element 202 is substantially equal to that of the light cover 208.

Now, the lighting board 214 will be described. Essentially, the lighting board 214 is a lighting device secured in the afore-said groove 212 so as to extend on and along the bottom surface of that particular groove 212, and adapted for introducing lights into the inside of the afore-said transparent element 202. The lighting board 214 itself comprises: a substrate 216 so configured as to be fitted in and along the recession 212; a pair of electrode patterns 128A and 128B formed on that substrate 216 in parallel with each other; and a plurality of LEDs 220 which are arranged on and along the substrate 216, such that each of the LEDs 220 bridges over the two electrode patterns 128A and 128B for electrical connection therebetween. The electrode patterns 128A and 128B may be formed from copper for instance and has been printed on the substrate 216 in advance. As shown, two terminals respectively of the two electrode patterns 128A and 128B are electrically connected with the respective two different leads 222 and 224. As far as the illustrated present embodiment is concerned, three LEDs 220 are arranged equidistantly from one another upon the substrate 216. Of course, a desired number of the LEDs 220 may be arranged appropriately on the substrate. Now, assembly of the present embodiment will be described, using the abovementioned parts and elements. At first, a predetermined number of the LEDs 220 are arranged on the substrate 216 having the two electrode patterns 128A and 128B formed thereon in parallel with each other, in such a manner that each of the LEDs 220 bridges over the two electrode patterns 128A and 128B, and then, two terminals (not shown) of each LED 220 are electrically connected with the two electrode patterns 128A and 128B, respectively. Thereafter, the two different leads 222 and 224 are electrically connected with such two terminals of each LED 220, respectively, by a suitable connecting means. Next, the thus-formed unit of substrate 216 with the LEDs 220 arranged thereon is firmly attached on the bottom surface of the groove 212 formed in the light cover 208, so that both substrate 216 and LEDs 220 are mounted in a bottom of the valley region of the light cover 208. Subsequent thereto, the transparent element 202 is lowered from the above down into the light cover 208, so that the convergent lower region of the transparent element 202 is fitted in and firmly attached to the corresponding valley region of the latter 208 by a suitable bonding means, such as adhesive agent

One of the afore-said two leads (the lead 224, for example), electrically connected with corresponding terminal of each LED 220, may be electrically connected to one terminal of a power source 228, whereas another of the two leads (the lead 222, for example), electrically connected with another corresponding terminal of the LED 220, be electrically connected to another terminal of the power source 228 via a switch 226. This arrangement is understandable from a circuit diagram in FIG. 9(C), wherein three LEDs 220, connected with one another in parallel, are electrically connected with the power source 228 via the switch 226. Hence, turning the switch 226 on and off causes the LEDs 220 to light on and go out, respectively.

Now, operation of the above-described present embodiment will be described. First of all, the light emission device 200 is installed at a desired location so that the curved surface region of the transparent element 202 (i.e. the region of substantially sector shape in section as stated earlier) is oriented towards a side or object to be illuminated by the light emission device. Thereafter, upon turning on the switch 226, a current is applied from the power source 228 to the LEDs 220 disposed in the groove 212. Then, the LEDs 220 start to light on, and emit and apply the respective lights thereof to the transparent element 202. The lights so applied to the transparent element 202 are refracted and dispersed in the substantially sector sectional region of that particular transparent element 202 which has a lens effect, whereupon some portions of the lights are emitted outwardly, while the other portions of the lights are applied to the light cover 208 from many angles. Among those dispersed lights, the afore-said the other portions of lights, which are applied to the light cover 208, are scattered on and by the surfaces of the light cover 208. Thus, when such illuminating state of light emission device 200 is viewed from the outside, it is observed that a whole of the transparent element 202 is illuminated uniformly with a high luminance. Accordingly, in the present embodiment, it is appreciated that the curved surface region of the transparent element 202 as well as the surface-treated frosted light cover 206 are effective in realizing uniform illumination with high luminance from a whole of the transparent element. Further, in the present Embodiment 6, as similar to the previously described Embodiment 1, there may be provided an alternative mode of light emission device, designated by 200A, as shown in FIG. 9(D), wherein a frosted light scattering region 203 is provided on the curved surface region of the transparent element 202.

### Embodiment 7

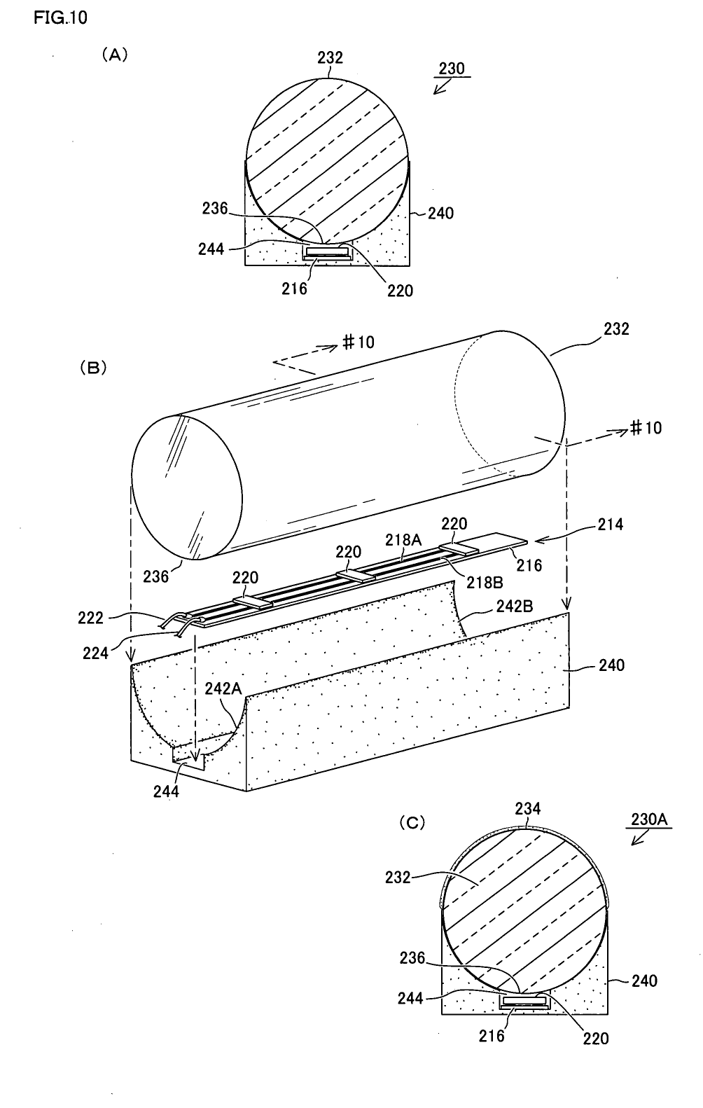

Referring to FIG. 10, a description will be made of the 7th embodiment of the present invention. The present embodiment provides a light emission device adaptable for use with substantially columnar transparent element having a substantially circular shape in section, instead of using the foregoing transparent element in the Embodiment 6. FIG. 10(A) is a sectional view showing a principal part of the present embodiment. FIG. 10(B) is an exploded perspective view illustrating a structure of the present embodiment. FIG. 10(C) is a sectional view showing a principal part of another alternative variant of the present embodiment. It is noted that the sectional part taken along the line #10-#10 in FIG. 9(B) as viewed in the arrow directions corresponds to the sectional illustration in FIG. 10(A). According to the present embodiment, a light emission device 230 is provided, which comprises: a transparent element 232 having a property that allows substantive light therethrough; a light cover 240 which also serves to scatter lights thereon, wherein the entire surfaces of that light cover 240 are processed by a suitable surface treatment to have a certain light diffusive property; and a lighting board 214 interposed between the transparent element 232 and the light cover 240.

The present embodiment is basically similar to the above-described Embodiment 6 in terms of structure. But, in this particular seventh embodiment, the light emitting device 230 employs a long transparent element 232 of substantially circular shape in section, and, in assembly, a light emission side of that transparent element 232 is naturally defined at a point where the corresponding outer surface region thereof is exposed from (not supported on) the light cover 240 upon which that particular transparent element 232 is mounted. On the other hand, genetically stated, the light cover 240 is so configured as to only cover a given surface portion of the transparent element 232, excluding the afore-said light emission side of the same 232. More specifically, the light cover 240 is so formed to have: a valley region which defines a pair of concavely curved surfaces 242A and 242B; and a groove 244 adapted for receiving the afore-said lighting board 214 therein, the groove 212 being defined in the bottom of such valley region so as to extend along the longitudinal direction of the light cover. As shown, the transparent element 232 is fitted in and firmly attached to both two concavely curved surfaces 242A and 242B by a suitable bonding means, such as an adhesive agent. For other several aspects, such as the structure of the lighting board 214 and electrical wiring of leads for the electrode patterns, the present embodiment is identical to those of the foregoing Embodiment 6. Also, in terms of all the light emitting manner and effects as well as advantages attainable therefrom, the present embodiment is indeed similar to the Embodiment 6. Of course, as shown in FIG. 10(C), there may be another mode of light emission device, designated by 230A, which has a frosted light scattering region 234 provided on the exposed outer surface region of the transparent element 232, wherein the said exposed outer surface region is a surface region of the transparent element 232 that are uncovered with the light cover 240.

### Embodiment 8

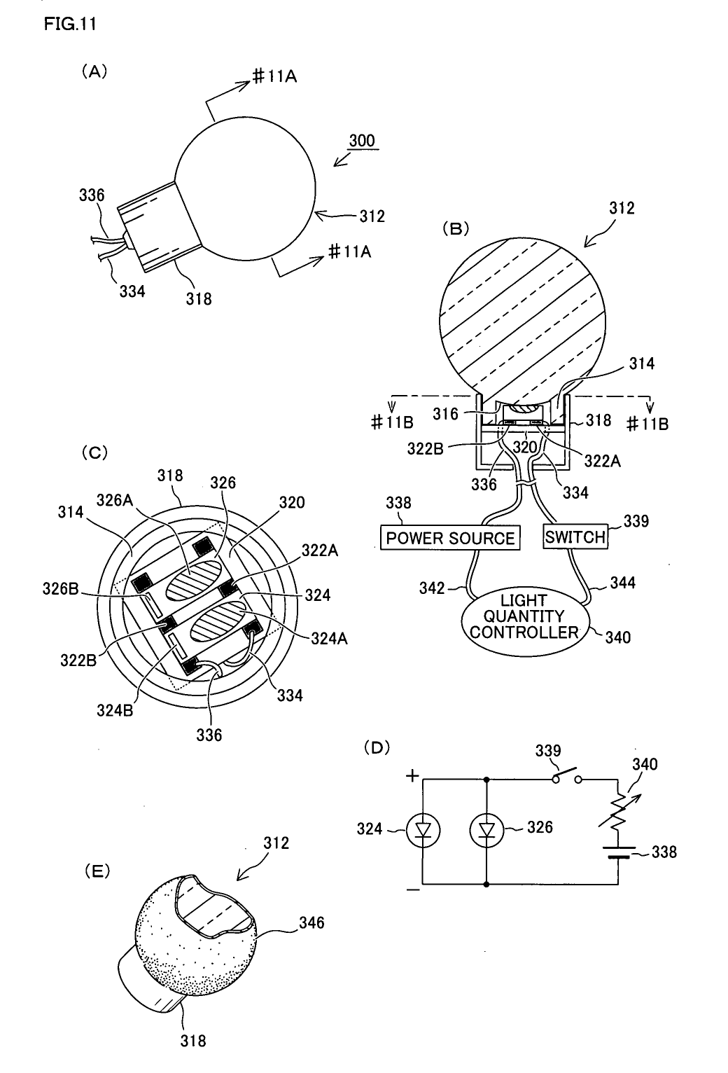

Reference is now made to FIG. 11. Description will be made of 8th embodiment of the present invention. According thereto, a light emission device of this particular mode is applied to an actual lighting equipment, by way of example. FIG. 11(A) is a perspective view showing an outer appearance of a whole lighting equipment to which the present mode is applied. FIG. 11(B) is a sectional view taken along the line #11A-#11A in FIG. 11(A), which shows a corresponding section of this embodiment as viewed in the arrow directions of the FIG. 11(A). FIG. 11(C) is a sectional view taken along the line #11B-#11B in FIG. 11(B), which shows a corresponding section of this embodiment as viewed in the arrow directions of the FIG. 11(B), wherein a disposition of light source (i.e. LEDs) is illustrated. FIG. 11(D) is a diagram of electric circuit used. FIG. 11(E) is a partly broken perspective view showing one variant of the present embodiment. As illustrated in FIG. 11, in the present embodiment, a light emission device 300 is provided, which comprises: a transparent element 312 having a property that allows substantive light therethrough; a pair of LEDs (light-emitting diodes) 324 and 326, which are a light source for emitting and applying light to the transparent element 312; a substrate 320 on which those two LEDs 324 and 326 are mounted, the substrate 320 being coupled with the transparent element 312; and a base 318 securely attached to the transparent element 312. The thus-constructed light emission device 300 may be securely attached at the base 318 thereof to a wall or ceiling, by a suitable connecting means. Further, a power source 338 and a switch 339 may be electrically connected with the two LEDs 324 and 326, and additionally, a light quantity controller 340 (variable resistance) be electrically connected with those particular LEDs in order to permit for adjustment of light quantity or luminance, as required.

The transparent element 312 is of a substantially spherical shape on the whole, and has a substantially circular shape in section, as seen from the sectional view of FIG. 11(B). Defined on a given local surface area of such transparent element 312 is a tubular portion 314 of substantially cylindrical configuration in which the afore-said substrate 320 is installed, so that the afore-said two LEDs 324 and 326 are accommodated in that tubular portion 314. In this regard, such particular tubular portion 314 may be formed integrally with the transparent element 312 as shown, or alternatively may be provided independently of the transparent element 312 and fixedly attached thereon by a suitable connecting means. Both of the transparent element 312 and tubular portion 314 may be formed from a material which is transparent and has a property that allows substantive light to pass therethrough, such as acrylic resin material or glass.

Further, in the present embodiment, the substrate 320, on which the two LEDs 324 and 326 are mounted, may be securely attached on a free end of the tubular portion 314, by a suitable connecting means. As far as the illustrative embodiment shown in FIG. 11(C) is concerned, a substantially square shape of substrate 320 is provided, and the four corner portions of that substrate 320 are securely attached on the free end of the tubular portion 314. In this particular mode, formed on an upper surface of the substrate 320 are a pair of electrode patterns 322A and 322B which are spaced apart from each other a predetermined distance and also extend in parallel with each other, and, with such electrode pattern arrangement, two terminals (not shown) provided in a reverse surface of each of the LEDs 324 and 326 can be electrically connected with the afore-said two electrode patterns 322A and 322B, respectively. Each of the electrode patterns 332A and 322B may be formed from copper or the like, for example, and have been printed on the substrate 320 in advance. In this context, a desired number of the LEDs may be provided on the upper surface of the substrate 320, but, as far as the shown embodiment is concerned, only a pair of LEDs 324 and 326 are provided on the substrate 320. Each of those LEDs is shaped in a substantially oblong or rectangular form. Those two LEDs 324 and 326 are respectively provided with light emission regions 324A and 326A in the respective upper surfaces thereof. It is noted here that each of those LEDs is not of a molded-resin type and therefore any resin layer does not cover each of the light emission regions 324A and 326A. Further, the two LEDs 324 and 326 are provided with the respective two polar markings 324B and 326B each being indicative of a certain pole associated with an electrode corresponding to one of the two LEDs 324 and 326. For example, in brief, a negative pole may be preset for one terminal provided in the reverse side of each of the two LEDs, wherein that particular terminal corresponds to one of the two polar markings 324B and 326B, and, in that case, both of those two polar markings 324B and 326B indicate negative pole.

Based on the foregoing arrangement and since a positive pole is set for another terminal of each of the two LEDS 324 and 326, such particular two positive terminals are then disposed on and electrically connected with the electrode pattern 322A, while on the other hand, the two negative terminals respectively of the two LEDs 324 and 326 are disposed on and electrically connected with the electrode pattern 322B. Further, two different leads 334 and 336 are electrically connected with the respective two ends of the two electrode patterns 322A and 322B. Among such two leads, the lead 336 extends to and is electrically connected with one terminal of the power source 338. In addition thereto, a lead 342, electrically connected with another terminal of the power source 338, is in turn electrically connected with one terminal of the light quantity controller 340. Further, a lead 344, electrically connected with another terminal of that light quantity controller 340, is in an electrical communication with the afore-said lead 334 by way of a switch 339.

Namely, as seen from the circuit diagram in FIG. 11(D), the present embodiment is of such an electrical arrangement that one set of the two LEDs 324 and 326 that are electrically coupled together in parallel is electrically connected with the power source 338 by means of the afore-said leads 334, 336, 342 and 344, with the switch 339 and light quantity controller 340 incorporated thereamong, so that turning the switch 339 on and off causes the LEDs 324 and 326 to light on and go out, respectively. In this regard, with the switch 339 turned on, the light quantity controller 340 may be operated to adjustingly increase or decrease a luminance or light quantity associated with the LEDs 324 and 326. Of course, depending on technical requirements, such light quantity controller 340 may be or may not be provided in this arrangement.

The above-constructed substrate 320 with the LEDs 324 and 326 arranged thereon are retained in the inside of the tubular portion 314 by being attached fast on the free end of that particular tubular portion 3104 via a suitable connecting means, such that the LEDs 324 and 326 are accommodated in place within the tubular portion 314. Securely attached on and about such tubular portion 314 is the previously stated base 318, by means of a suitable connecting means, wherein it is seen that the base 318 has an opening side defined at the upper end thereof, and such opening side of the base 318 18 is securely attached on and about the tubular portion 314. The base 318 also has a hole defined in the bottom wall thereof, through which hole, the afore-said leads 334 and 336 extends outwardly. With regard to the tubular portion 314 and base 318, by way of one example, an outwardly threaded portion may be formed in the outer circumferential surface of the tubular portion 314, whereas an inwardly threaded portion be formed in the inner circumferential surface of the base 318 within a limited range from the upper end of that base. (Note that such outwardly and inwardly threaded portions are not shown in the drawings.) In that instance, by threaded engagement of the outwardly threaded portion with the inwardly threaded portion, the base 318 may be securely engaged about the tubular portion 314. Hence, such threaded engagement arrangement allows a releasable connection of the base 318 with respect to the tubular portion 314. It is noted here that the tubular portion 314 is preset as to its outward projection from the transparent member 312 to such an extent that the LEDs 324 and 326, mounted on the substrate 320 attached on that tubular portion 314, are disposed adjacent to and out of contact with an outer surface of light introduction area 316 of the transparent element 312, wherein the light introduction area 316 is an area through which lights from the LEDs are introduced into the inside of the transparent element.

A description will be made of operation of the present embodiment. At first, the light emitting device 300 is installed, by a suitable means, on a desired location where illumination is required. Then, the switch 339 is turned on, so that a current is applied from the power source 338 to the two LEDs 324 and 326 provided in the tubular portion 314, with the result that both two LEDs 324 and 326 emit lights therefrom, and such lights in turn pass through the light introduction area 316 and are introduced into the transparent element 312. At this moment, the lights entering the transparent element 312 are refracted and dispersed due to a lens effect caused by the substantially circular section of the transparent element 312, as discussed earlier, and then emitted outwardly therefrom. Hence, when the light emission device 300 is viewed from the outside, it is observed that a whole of the transparent element 312 is illuminated uniformly with high luminance. Additionally, according to the present mode of light emission device 300, the afore-said lens effect advantageously achieves a required high luminance of the lights, thus providing a more satisfied bright illumination than incandescent lamp and the like.

As described above, in accordance with the present Embodiment 8, the tubular portion 314 is provided on the outer surface of the substantially spherical transparent element 312 having a property that allows substantive light to pass therethrough, and further, disposed within that tubular portion 314 are the two LEDs 324 and 326 so as to be in proximity to and out of contact with the light introduction area 316. Thus, lights emitted from the LEDs 324 and 326 are reflected due to a lens effect inherently provided at inner surface of the transparent element 312, and thus refracted and diffused in that particular transparent element 312. Since such diffused lights are emitted outwardly therefrom, a whole of the transparent element 312 is illuminated uniformly, and further, a high luminance of light is attainable to provide a satisfied bright illumination.

With reference to FIG. 11(E), one variant of the present eighth embodiment will be described. As seen in FIG. 11(E), surfaces of the transparent element 312 are treated such that all the outer surface areas thereof, excepting the inner side of the afore-said tubular portion 314 or excepting the afore-said light introduction area 316, are provided with a frosted light scattering region 346 thereon, while on the other hand, such particular light introduction area 316 is only transparent. In other words, the outer surface region of the tubular portion 314 is also provided with the frosted light scattering region 346 thereon. This frosted light scattering region 346 is a film effective in causing light to reflect diffusely therefrom, the film being for example formed by evaporating or applying a coating material to the corresponding surface region of the transparent element 314, wherein the said coating material contains a suitable white pigment. In this regard, such white pigment may be a white titanium pigment (i.e. titanium white, or titanium oxide), for instance, but may include other sorts of white pigments, such as silver white or zinc white. Hence, with this arrangement, lights emitted from the LEDs 324 and 326 are first refracted and diffused due to the lens effect of transparent element 312 and advance radially toward the light scattering region 346. At this moment, the lights passing through the frosted layer of light scattering region 346 are efficiently scattered (or reflected diffusely) in many directions. Accordingly, this particular mode insures to provide a far improved uniformity of light being emitted outwardly.

### Embodiment 9

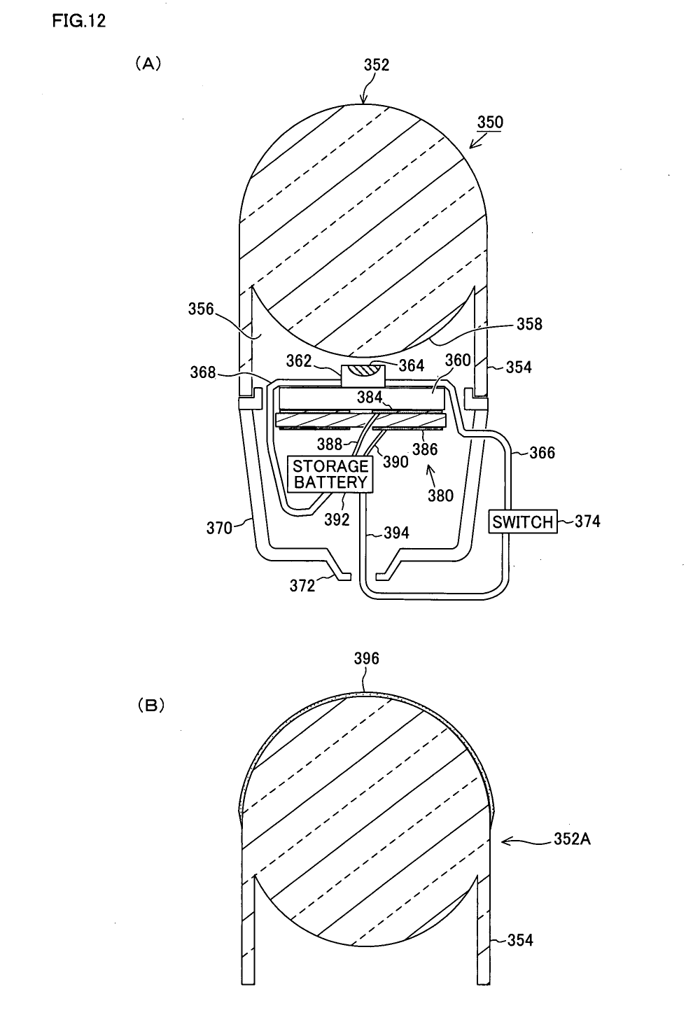

Reference being now made to FIG. 12, the 9th embodiment of the present invention will be described. FIG. 12(A) is a sectional view showing a principal part of this particular embodiment. FIG. 12(B) is a sectional view showing a principal part of one variant of the present present invention. Likewise as in the foregoing Embodiment 8, a light emitting device of the present Embodiment 9 is also applied to an actual lighting equipment, by way of example, and basically similar in structure to that Embodiment 8, except that a solar battery is employed as the power source. At first, with particular reference to FIG. 12(A), a light emission device 350 in accordance with the present Embodiment 9 will be described. The light emission device 350 is comprised of: a transparent element 352 which can be illuminated; a LED 363 for emitting and applying light to the transparent element 352; and a base 370. Further, in the light emission device 350, a switch 374, a solar battery panel 380 and a storage battery 392 are incorporated for electrical connection with the LED.

As shown in FIG. 12(A), the transparent element 352 is configured such that the body thereof is basically formed in a substantially spherical shape and has a tubular portion 354 of substantially cylindrical shape defined thereon, wherein such tubular portion 354 extends continuously and outwardly from the spherically shaped body of transparent element 352. Securely attached by a suitable means upon a free end of the tubular portion 354 is a substrate 360 on which the afore-said LED 362 is mounted. With this arrangement, it is to be seen that the LED 362 is accommodated within a storage space 356 defined inwardly of the tubular portion 354. In this regard, the tubular portion 354 is preset as to its outward projection from the transparent element 352 to such an extent that the LED 362 in the storage space 356 is disposed adjacent to and out of contact with a light introduction area 358 defined on the outer surface of the transparent element 352. While having described above, the transparent element 352 itself may be formed in any proper manner. That is, for example, the spherical body thereof and the tubular portion 354 may be provided independently of each other, and then, those two elements be firmly attached together in assembly. Or, alternatively, a raw material for creation of that transparent element 352 be provided, and then, a given local portion thereof be cut away so as to form one unitary transparent element 325 of the illustrated configuration wherein the spherical body thereof and the tubular portion 354 are integral with each other. The transparent element 325 may be formed from a proper material having a property that allows light to pass therethrough, such as acrylic resin material or glass, likewise as in the foregoing Embodiment 8.

By a suitable connecting means, the LED 362, a light source, is securely mounted on a substantially central area of the substrate 360 attached to the free end of the tubular portion 354. The LED 362 has a light emission region 364 defined in the upper surface thereof, without any resin layer on such light emission region because the LED 362 is not of any molded-resin type. Though not shown, two terminals are respectively provided to two opposite lateral surfaces of the LED 362, and two different leads 366 and 368 are electrically connected with such two terminals of the LED 362, respectively. In this respect, for example, the lead 366 may be extended to the outside from the base 370 through a given upper region of lateral surface of that particular base 370, and is further electrically connected with one terminal of the switch 374. On the other hand, the lead 368 be electrically connected with one terminal of a storage battery 392 provided within the base 370. Further, electrically connected to another terminal of the storage battery 392 is a lead 394 which in turn extends through a lead port 372 to the outside and is electrically connected with another terminal of the switch 374.

In the present embodiment, the afore-said substrate 360 is formed from a transparent plate material which permits light to pass therethrough, thereby allowing sunlight to pass through that substrate 360 and to be applied to the afore-said solar battery panel 380. It is noted that, responsive to sunlight being applied thereto via the substrate 360, the solar battery panel 380 operates to convert energy of that sunlight into an electrical energy, and for that purpose, the solar battery panel 380 includes, attached thereto, a P-type semiconductor plate and a N-type semiconductor plate, through not shown, and also has a pair of electrode layers 384 and 386 having an electrical connection with such two semiconductor plates, respectively, so that, in operation, an electricity can be gained from both front and reverse sides of each of the P-type and N-type semiconductor plates. The afore-said two electrode layers 384 and 386 are electrically connected with the storage battery 392 by way of the corresponding two leads 388 and 390, whereby an electrical energy gained from the solar battery panel 380 is to be converted in the storage battery 392 into a chemical energy which is in turn to be accumulated in that storage battery 392, while allowing a certain amount of the thus-accumulated chemical energy to be converted into a required amount of electrical energy. Thus, when it is required to supply an electricity to the LED 362, the accumulated chemical energy may be converted in the storage battery 392 into electrical energy, and thus, a required amount of current is supplied therefrom to the LED 362. The storage battery 392 is electrically connected with one terminal of the LED 362 by means of the lead 368, while being electrically connected with the switch 374 by means of the lead 394. With such arrangement, the switch 374 may be turned on to cause the LED 362 to light on, or turned off to cause the same to go out, selectively. Of course, depending on technical requirement, a light quantity controller may be incorporated in the present mode of light emitting device so as to permit for adjustment of light quantity of the LED.

Now, a description will be made of operation of the present embodiment. At first, the light emission device 350 is installed on a desired location by a suitable means. Then, the switch 374 is turned on, responsive to which, a current is supplied from the storage battery 392 to the LED 362 disposed in the storage space 356, so that the LED 362 emits light therefrom toward the transparent element 352. The light then passes through the light introduction area 358 and enters the inside of the transparent element 352. At this moment, the light is reflected by the curved inner surface of the transparent element 352 and diffused therein due to the lens effect of that transparent element 352 of lens-like body configuration. Hence, when such lighting state of the light emission device 350 is viewed from the outside, it is observed that a whole of the transparent element 352 is illuminated uniformly with a high luminance, thereby providing a satisfied bright illumination. All other effects and advantages of the present mode are similar to the previously described effects and advantaged of the Embodiment 8. As shown in FIG. 12(B), a frosted light scattering region 396 may be formed on the surface of a transparent element identical to the foregoing transparent element 352, so that, as designated by 352A, a surface treated mode of transparent element is provided, which is intended to attain a more uniform illumination. Likewise as in the Embodiment 8, the frosted light scattering region 396 must only be formed on an outer surface region of transparent element opposite to the tubular portion 354. With regard to a range within which to form the light scattering region 395, as similar to the aforementioned modified mode of the Embodiment 8, the light scattering region 396 must only be formed on that outer surface side of the transparent element which is, otherwise stated, a light emission surface region of the transparent element from which light is to be emitted outwardly.

### Embodiment 10

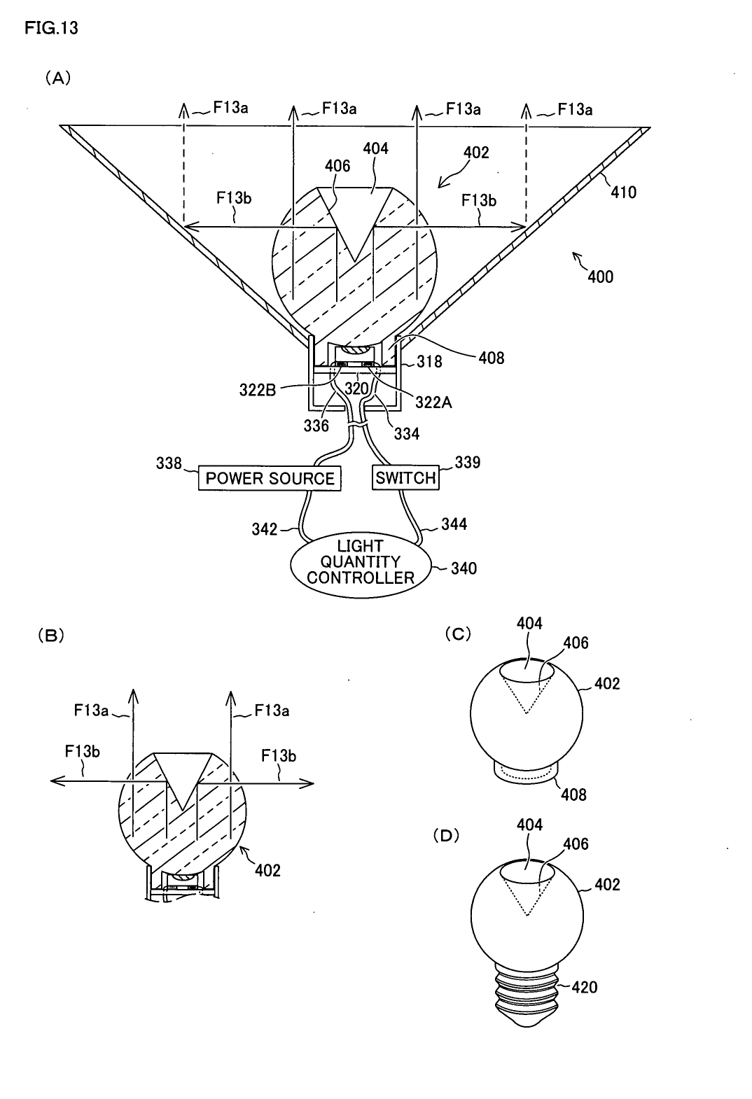

Reference being made to FIG. 13, a description will be made of the 10th embodiment of the present invention. FIGS. 13(A) and 13(B) are two sectional views illustrative of a principal part of the present embodiment. FIG. 13(C) is a perspective view showing a transparent element used in the present embodiment. FIG. 13(D) is a perspective view showing a whole appearance of one variant of the present embodiment. It is to be noted that some constituent elements of the present embodiment are identical to those of the foregoing Embodiment 8, and that some constituent elements are commonly used between those two embodiments, although they are identified by designations in the Embodiment 8, while not so identified in the present embodiment. Thus, it should be understood that all like designations to be given hereinafter correspond to all like designations that have been used in the Embodiment 8. (The same goes for all other embodiments that will be described later.) As similar to the foregoing Embodiments 8 and 9, the present tenth embodiment is also based on the arrangement employing a substantially spherical shape of transparent element. In accordance with the present embodiment, as shown in FIGS. 11(A) and 11(B),a light emission device 400 is provided, which comprises: a transparent element 402 that can be illuminated; two LEDs 324 and 326 which are a light source for applying light to the transparent element 402; a substrate 320 securely provided to the transparent element 402; a base 318 securely attached to the transparent element 402; and a substantially bell-shaped cover or shade 410 that extends radially and outwardly from the transparent element 402. As will be described, the shade 410 may or may not be provided, depending on situation and requirements. It is noted that the arrangement of LEDs 324 and 326, substrate 320, and cylindrical support frame 318 as well as electric circuit arrangement associated therewith are basically similar to those of the Embodiment 8.

The transparent element 402 is of a substantially spherical shape on the whole and has a substantially conical recession 404 formed in the light emission region thereof (i.e. an outer region of that transparent element, from which light is to be emitted outwardly), as shown in FIG. 13(C). According to the present embodiment, a tubular portion 408 of substantially cylindrical shape is defined in a local region of the transparent element 402 which is just opposite to the afore-said recession 404. The substrate 320 is securely attached to such tubular portion 408, with both two LEDs 324 and 326 accommodated within that particular tubular portion 408. In this context, the tubular portion 408 may be integral with the transparent element 402, or alternatively, the tubular proton 480 and transparent element 402 be provided independently of each other and fixedly connected together by a suitable means, in assembly. Likewise in the Embodiment 8, both tubular portion 480 and transparent element 402 may be formed from a material having a property that allows substantive light to pass therethrough, such as acrylic resin material or glass. As shown n FIG. 13(A), depending on requirements, the substantially bell-shaped cover or shade 410 adapted for reflecting light therefrom may be provided so as to extend radially and outwardly from the transparent element 402. This shade 410 may, for example, be formed from a mirror-finished material, such as a mirror-finished aluminum material or a mirror-finished resin material.

Now, operation of the above-described mode of light emission device will be described. First of all, a description will be made for the case where the shade 410 is provided to the light emission device 400. Such light emission device 400 is installed by a suitable means at a desired location where illumination is required. Then, upon the switch 339 being turned on, a current is supplied from the power source 338 to the two LEDs 324 and 326 provided in the tubular portion 408, so that the LEDS 324 and 326 emit the respective lights within the tubular portion 408, and then the lights are applied therefrom to the transparent element 402. After the lights have entered the transparent element 402, some portions of the lights are applied to a sloped surface 406 of the afore-said recession 404 and reflected thereby to the outside; namely, in a direction (as indicated by the directions of arrows F13b) substantially orthogonal with a direction in which the other portions of the lights are emitted straightforward and outwardly from the transparent element 402. The thus-reflected portions of lights advance in that direction and are further reflected by the shade 410, as a result of which, such light portions advance as indicated by the dotted lines in the FIG. 13(A), which means that their directions are changed upwardly (as indicated by the arrows F13a). On the other hand, some other portions of the lights emitted from the LEDs 324 and 326, which have entered the transparent element 402 at a point distant outwardly from the afore-said recession 404, pass straightforward through the transparent element 402, without being reflected by that recession 404, as indicated by the solid lines in FIG. 13(A), which means that such particular portions of the lights are emitted in the upward direction only (as indicated by the arrows F13a). Accordingly, it is appreciated that, with the provision of shade 410, substantive portions of the lights, which enter the transparent element 402, are emitted outwardly in one and same direction therefrom.

Reference is made to FIG. 13(B) which shows the transparent element 402 without any shade 410 provided thereto. In that particular mode, it is seen that some portions of the lights emitted from the LEDs, which have been reflected by the afore-said recession's sloped surface 406, advance straightforward, without changing their directions, as indicated by the arrows F13b. On the other hand, the other portions of the lights emitted from the LEDs, which have entered the transparent element 402 at a point distant outwardly from the afore-said recession 404, pass straightforward through the transparent element 402, without being reflected by that recession 404, and are emitted outwardly in one direction only, as indicated by the arrows F13a in the FIG. 13(B). Hence, according to such arrangement without any provision of the shade 410, it is appreciated that some portions of the lights are emitted outwardly in a direction indicated by the arrows F13a, while the other portions of the lights are emitted outwardly in another direction indicated by the arrows F13b, which is substantially orthogonal with the afore-said directions F13a. It is noted that other effects and advantages attainable from the present embodiment are entirely similar to those of the Embodiment 8. It is also noted that, as shown in FIG. 13(D), in place of the base 318, another mode of base 402 may be used, which is of the type having threaded engagement portion formed thereabout. In that case, it is possible to directly engage that base 402 in an ordinary socket or the like, which makes it quite easy to install the light emission device at a desired location.

As described above, in accordance with the present embodiment, the lights emitted from the LEDs 324 and 326 are reflected due to the above-discussed lens effect of the transparent element 402 of substantially circular shape in section, and thus refracted and diffused in that transparent element 402, so that the thus-diffused lights are emitted outwardly therefrom. Hence, when such lighting state of the light emission device 400 is viewed from the outside, it is observed that a whole of the transparent element 402 is illuminated uniformly and with a high luminance. In particular, since the afore-said lens effect is enhanced more efficiently in the present embodiment, it is possible to achieve a high luminance of light emitted, thus providing a more sufficient bright illumination than an incandescent lamp or the like. Moreover, in the present embodiment, by providing and removing the shade 410 to and from the light emission device, it is possible to adjustably change the range and direction in which the light is to be emitted outwardly.

### Embodiment 11

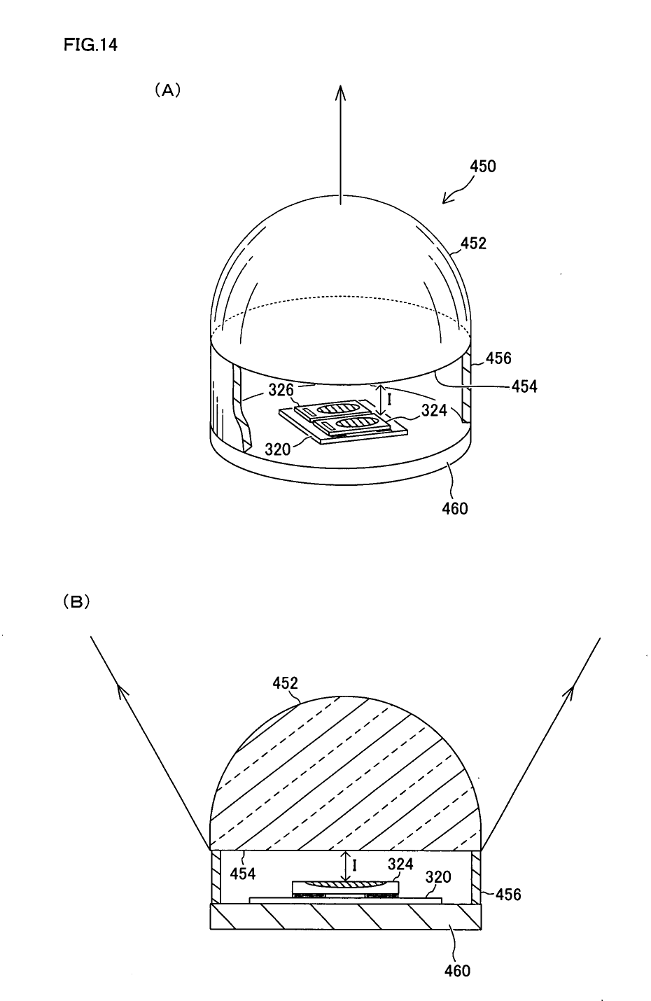

Reference being made to FIG. 14, a description will be made of the 11th embodiment of the present invention. FIG. 14(A) is a perspective view showing the present embodiment. FIG. 14(B) is a sectional view of the present embodiment. While all of the foregoing Embodiments 8 to 10 use a substantially spherical shape of transparent element, the present eleventh embodiment employs a substantially semispherical shape of transparent element. As seen in FIG. 14, in this particular embodiment, a light emission device 450 is provided, which comprises: a transparent element 452 that can be illuminated by light; two LEDs 324 and 326 which are a light source for emitting and applying light to the transparent element 452; a substrate 320; and a base portion 460 on which the substrate 320 is securely mounted. It is noted that the LEDs 324, 326 and the substrate 320 as well as electric circuit arrangement associated therewith are identical to those of the previously described Embodiment 8.

The transparent element 452 per se is of a substantially semispherical shape having a flat surface region 454. and also has a tubular portion 456 securely attached on and along the peripheral end portion of that flat surface region 454, wherein the tubular portion 456 is configured for connection with the afore-said base portion 460 of substantially circular shape. Namely, the base portion 460 is fixedly connected with the tubular portion 456, and therefore, the tubular portion 456 is interposed between the foregoing flat surface region 454 and the base portion 460. In this regard, the tubular portion 456 should have a width to provide a distance between those flat surface region 454 and base portion 460, such that a predetermined space I is essentially given between the flat surface region 454 and the two LEDs 324, 326 mounted on the base portion 460. The transparent element 452 itself may be formed from a proper material that allows substantive light to pass therethrough, such as acrylic resin material or glass. The operation and effects of the present embodiment are basically similar to those of the Embodiment 8. That is, in the present embodiment, an air zone is naturally defined between the transparent element 452 and the LEDs 324, 326, and therefore, lights emitted from such LEDs expand freely in that air zone and are applied to the transparent element 452 from many angles. In addition thereto, the lights entering and passing through the transparent element 452 are refracted and diffused due to a lens effect caused by the substantially arcuate section of the transparent element 452. Accordingly, a high luminance of light is emitted outwardly from the transparent element 452 to provide a satisfied bright illumination. In this context, in the present embodiment, the space I between the flat surface region 454 and the LEDs 324, 326 may be increased and decreased to permit for adjustably changing the manner in which the lights are to be emitted outwardly from the transparent element 452. Namely, with such adjustment of the space I, it is possible to cause the lights to emit as a ray of light from the transparent element 452 in one direction, as shown in FIG. 14(A), or to cause the lights to emit radially from the transparent element 452, as shown in FIG. 14(B). It is noted that effects attainable by the present embodiment are similar to those of the previously described Embodiment 8.

### Embodiment 12

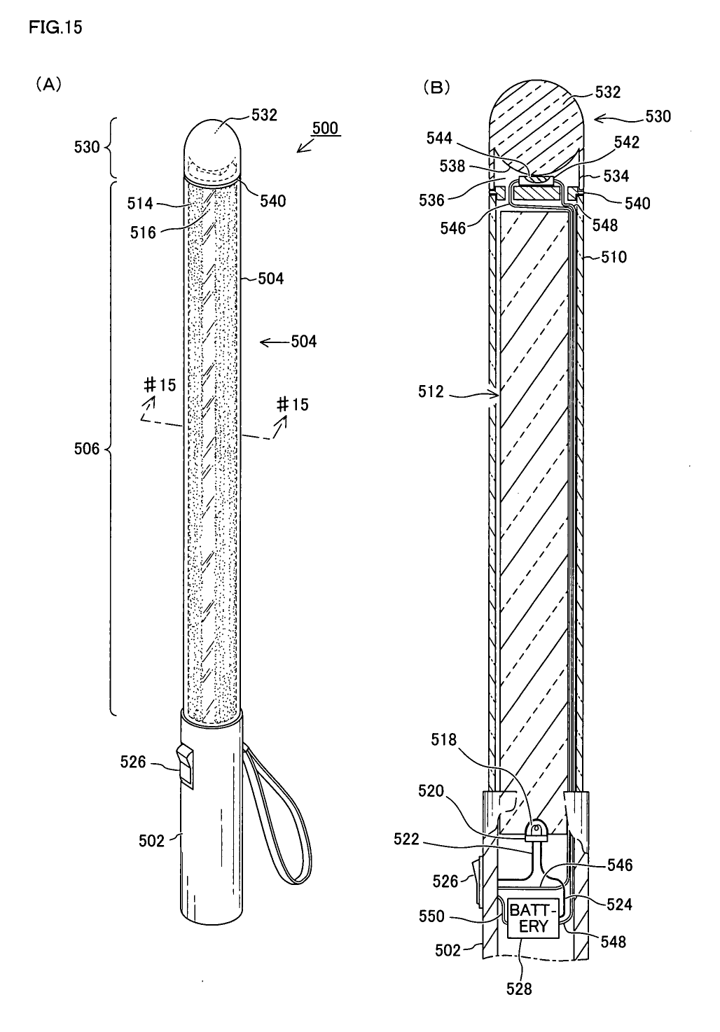

Reference being made to FIG. 15, a description will be made of a 12th embodiment of the present invention. While all of the foregoing Embodiments 8 to 11 use nothing but one substantially spherical or semispherical shape of transparent element, the present embodiment is directed to a light emission device employing a combination of: a substantially spherical shape of transparent element; and a long columnar configuration of transparent element. As illustrated, this particular 12th embodiment is applied to a baton or police baton. FIG. 15(A) is a perspective view showing a whole appearance of the present embodiment. FIG. 15(B) is a sectional view taken along the line #15-#15 in FIG. 5(A), which shows a principal part of the present embodiment, as viewed in the arrow directions of the FIG. 5(A).

Referring to FIGS. 15(A) and 15(B), in the present embodiment, three is illustrated a baton 500 which basically comprises a grip 502 and main body 504. The main body 504 is comprised of: a first light emission section 506 of a long columnar configuration; a second light emission section 530 of a substantially spherical shape; and an attachment 540 for connecting together those two light emission sections. Of course, one same color of light may be emitted from both two light emission sections 506 and 530, but, in the description hereinafter, let us assume that a red light is to be emitted from the first light emission section 506, while a white light from the second light emission section 530, by way of one example.

At first, the first light emission section 506 will be described. This light emission section 506 assumes a rectilinearly extending long configuration. Generally stated, in most cases, an actual illumination provided by such rectilinear long body is uneven and unstable, such that, the nearer to a light source the light emission point thereof, the higher becomes a luminance or brightness thereat, whereas by contrast, the remoter away from the light source the light emission point thereof, the lower or dimmer becomes the brightness thereat. The present embodiment is therefore intended to avoid such uneven state of luminance or brightness, and provide a uniform bright illumination from the entire body thereof. Namely, the first light emission section 506 is composed of a cylindrical member 510 and a transparent element 512 accommodated in the cylindrical member 510, wherein the transparent element 512 is of a substantially columnar configuration formed from a proper transparent material that allows substantive light to pass therethrough. The cylindrical member 510 is also formed from a transparent material, such as a transparent resin material or glass, which in no way prevents passage therethrough of a light from the transparent element 512.

The transparent element 512 is formed with a frosted light-scattering region 514 on the substantially entire outer surfaces thereof, excepting a rectilinear transparent window 516 which is formed on a local surface area of the transparent element 512 and extends along the longitudinal direction of the latter. As similar to the previously described embodiments, the transparent element 512 may be formed from a proper material, such as an acrylic resin material or glass, and the light scattering region 514 be a film formed on the outer surfaces of the transparent element 512 by evaporating or applying a coating material thereto, for example, wherein the coating material contains a white pigment therein. One end of this transparent element 512 (corresponding to a side where the grip 502 is provided, as far as the illustrated embodiment is concerned) has a LED 518 embedded securely therein. The LED 518 is mounted on a substrate 520 form which two different leads 522 and 524 extend outwardly. In this respect, while not shown, those two leads 522 and 524 are electrically connected with respective two terminals (not shown) of the LED 518. LED 518 used in the present embodiment is adapted for emitting a red light therefrom, so that the first light emission section 506 is to be illuminated with red light. The afore-said one end of the transparent element 512 as well as the adjoining one end of the cylindrical member 510 are supportively secured in the grip 502 by a suitable connecting means, so that the LED 518 is accommodated in that particular grip 502.

The grip 502 has a hollow defined therein, and a power source or battery 527 is provided in that hollow of grip 502. Further, the grip 502 is provided with a switch 526 on the outer surface thereof, the switch 526 being adapted for selectively causing a light to light on or go out for each of the first and second light emission sections 506 and 530. A lead 550, electrically connected with one of two terminals (not shown) of the battery 528, is in an electrical communication with one of the afore-said two terminals (not shown) of the LED 518 by way of the aforementioned switch 526 and lead 522. Also, another of the afore-said two terminals of battery 528 and another of the afore-said two terminals of LED 518 are electrically connected together by means of a lead 524. The three leads 522, 524 and 550 are all accommodated in the hollow of the grip 502.

A description will be made of the second illumination section 530. Structure of such second light emission section 530 is basically similar to that of the previously described Embodiment 8. Specifically stated, the second light emission section 530 is comprised of: a transparent element 532 of substantially spherical shape which can be illuminated by light; a tubular portion 534 provided on the transparent element 532; a LED 542 that are a light source for emitting and applying light to the transparent element 532; and an attachment 540 having a surface on which the LED 524 is mounted. The transparent element 542 is securely attached by the attachment 540 to the previously mentioned cylindrical member 510. In the present embodiment, the LED 542 is adapted for emitting a white light therefrom, so that the second light emission section 530 is to be illuminated with a white light. A power source for that LED 542 is the afore-said battery 528 that is provided in the grip 502. Likewise as in the foregoing embodiments, both of the transparent element 532 and tubular portion 534 may be formed from a proper material that allows substantive light to pass therethrough, such as acrylic resin material or glass.

The transparent element 532 is formed to have, defined integrally therein, a main body portion of substantially spherical shape and a tubular portion 534 of substantially cylindrical shape, such that the tubular portion 534 extends continuously and outwardly from the main body portion. The afore-said attachment 540, on which the LED 542 is mounted, is securely connected with and along the peripheral end of the tubular portion 534, by a suitable connecting means, the tubular portion 534 having a storage space 536 defined therein. Hence, it is seen that the LED 542 is accommodated in that storage space 536. With regard to the transparent element 532 per se, the main body portion thereof and the tubular portion 534 thereof may be provided independently of each other and fixedly coupled together in assembly. Or, alternatively, a raw material may be formed by cutting out given local areas thereof into one unitary configuration wherein both main body portion and tubular portion 534 are integral with each other.

The LED 542, a light source, is securely mounted on a substantially central point of the afore-said attachment 540 by a suitable connecting means, wherein the attachment 540 is secured to and along the peripheral end of the tubular portion 534 as stated above. This LED 542 is provided with a light emission region 544 in the upper surface thereof. It is noted here that the light emission region 544 is not covered with any resin layer, since the LED 542 is not of a molded-resin type. Further, the LED 542 has two terminals provided in the respective two opposite lateral surfaces, though not shown, and two different leads 546 and 548 are electrically connected with such two terminals of the LED 542, respectively. For example, as illustrated, those two leads 546 and 548 extend through the attachment 540 into the second light emission section, and the lead 546 is electrically connected with the afore-said one of two terminals of the switch 526, while the lead 548 is electrically connected with the afore-said one of two terminals of the battery 528. In this context, it is to be seen that the afore-said one terminal of the LED 518 as well as one of the two terminals of the LED 542 are in electrical communication with the afore-said one terminal of the battery 528 by way of the respective two leads 524 and 548. Also, it is to be seen that the afore-said another terminal of the LED 518 and another of the two terminals of the LED 542 are in electrical communication with the afore-said one terminal of the switch 526 by way of the respective two leads 522 and 546. Further, the afore-said another terminal of the switch 526 and the afore-said another terminal of the battery 528 are electrically connected together by means of the lead 550. Accordingly, with such arrangement, operation of the switch 526 causes the LED 518 to selectively either light up or go out, while causing the LED 542 to selectively either light up or go out. In this regard, it may be arranged such that both two LEDs 518 and 542 will light up at the same time upon operation of the switch 526, or alternatively, one of the two LEDs 518 and 542 will glow, while another of them will stay out, by operation of the switch 526.

Next, operation of the present embodiment will be described. It should be understood that all actions of the two LEDs 518 and 542, which will be hereinafter simply represented by the verbs, “light up”, “lit up”, “go out”, and “gone out”, are executed by operation of the switch 526. Now, at the first step, upon the LED 518 having been lit up, a light emitted form that LED 518 enters the inside of the transparent element 512. With regard to the light that has entered the transparent element 512, a certain portion of the light advances to the transparent widow 516 and is reflected by that particular transparent window 516, whereas the other portion of the light advances to the frosted light scattering region 514 and is diffusely reflected (or scattered) by that particular light scattering region 514. Precisely stated, most of the light that has entered the inside of the transparent element 512 is mainly guided by and along the transparent window 516, such that the light runs upwardly in a direction from a lower end to an upper end of the transparent window 516. At the same time, the light being so guided and reflected by that window 516 is also diffusely reflected by the light scattering region 514. Consequently, when the first light emission section 506 is viewed from the outside, it is observed that a whole body thereof provides red illumination.

On the other hand, upon lighting up the LED 542, a light is emitted therefrom and passes through a light introduction area 538 towards the transparent element 532. The light entering that transparent element 532 is refracted and diffused due to the lens effect caused by the substantially circular section of the transparent element 532, and emitted outwardly therefrom. Thus, when such lighting state of the baton 500 is viewed from the outside, it is observed that a whole of the second light emission section is illuminated uniformly with a high luminance.

As described above, in accordance with the present 12th embodiment, the first light emission section 506 is of such arrangement that a substantive outer surface portion of the transparent element 512 is formed with the frosted light scattering region 514, excepting the transparent window 516 formed along the longitudinal direction of the transparent element 512. Thus, the transparent window 516 serves to guide the light therealong to an upper region of the transparent element 512, whereupon a whole of the transparent element 512 is uniformly illuminated up to the upper distal end thereof. On the other hand, with regard to the second light emission section 530, upon the LED 542 having been lit up, a light emitted therefrom enters the transparent element 512 and is reflected by the arcuate inner surface of the transparent element 512 which provides a lens effect. Thus, the light is refracted and diffused in the transparent element 512, and then emitted outwardly therefrom. Consequently, the second light emission section 530 is illuminated uniformly, thereby providing a satisfied bright illumination. Of course, in the present embodiment, likewise as in the previously described embodiments, the outer surface of the transparent element 532 in the second light emission section 530 may be formed with a frosted light scattering region or layer, as by evaporating and depositing a proper coating material thereon.

It is to be noted that many various embodiments of the present invention may be created without departing from the scopes of the appended claims, and, based on such understanding, a great number of further variants be provided by modifying each of the above-disclosed embodiments. For example, the following modes and conditions are encompassed by the scopes of the present invention.

(1) The shapes and sizes of constituent elements stated in the previously described embodiments are suggested by way of one example and thus may be altered appropriately insofar as they achieve the same effects as in the previous embodiments. In particular, in the case of the afore-said rectilinear columnar transparent element being used, the longitudinal sizes and dimensions thereof may be increased or decreased to a desired degree. Also, in the case of the afore-said substantially spherical or semispherical transparent element being used, the diameter thereof be increased or decreased to a desired degree.

(2) The transparent element may preferably be formed from a transparent and colorless material, but may be formed from a material having a certain color. For example, in the foregoing Embodiment 12, the first light emission section 506 uses the LED 518 of red color which is adapted for emitting a red light therefrom whereas the second light emission section 530 uses the LED 542 of while color which is adapted for emitting a white light therefrom. This is however just one example, and any other LEDs of different colors than those red and white colors may be used, as required.

(3) Most of the foregoing embodiments indicates an example of using a transparent element of acrylic resin material or glass. But this is just one example, and the transparent element be formed from any one of various known sorts of materials that allow substantive light to pass therethrough, according to a particular technical requirement. For example, in the case where the light emission device of the present invention is attached to a ceiling as a lighting equipment, a transparent element used may be formed from a flame retardant transparent resin material.

(4) In place of the LED(s), other suitable kinds of light sources may be used. For example, a cold-cathode tube be employed. But, from the viewpoint of low power consumption, the LED is still recommended as an optimum light source.

(5) The LED(s) may be of a monochromatic type adapted for emitting a monochromatic light therefrom, or of a polychromatic type adapted for emitting a polychromatic light therefrom.

(6) The above-specified number of the LEDs in each of the foregoing embodiments is also given as one example, and therefore, a desired number of the LED(s) may be provided, depending on requirements.

(7) The light emission devices described in the foregoing Embodiments 8 to 12 are not limited for mere ordinary light emission purpose inside or outside the house, but may be used for illuminating various kinds of displays or signboards.

(8) In the foregoing Embodiment 9, the solar battery panel 380 is provided in the light emission device 350. But, this is just one example, and the solar battery panel 380 may be provided exteriorly of the light emission device 350. Of course, such solar battery panel 380 may be used in each of other embodiments described above.

(9) Each of the electric circuit arrangements in the previously described embodiments is also provided by way of one example and may be altered into any other proper arrangement, insofar as it achieves the same effects as in the foregoing embodiments. For example, any one of the circuit arrangements in FIGS. 2(B) to FIG. 2(E) may be altered to the circuit arrangement in the Embodiment 1, or altered to one of the circuit arrangements in the Embodiments 2 to 7. Additionally, to each of those electric circuits, a naturally occurring power source, such as a solar battery or wind power, may be provided, thereby making it possible to not only reduce running costs involved, but also realizing an environmentally-friendly illumination.

Moreover, for example, the light quantity controller 340 used in the Embodiment 8 may be incorporated in the circuitry of each of other embodiments describe above, depending on requirements. Still further, with regard to the Embodiment 9, a photodetector be used in place of the switch 374 as a switch means for causing the LED 362 to either light on or go out. In that instance, it may be arranged for example such that the photodetector detects an amount of sunlight and sends the same to a control unit. Namely, if the photodetector detects a great amount of sunlight that exceeds a predetermined level (that is, in the sunny daytime, for example), the control unit will stop supplying any current to the LED 362. By contrast, if the photodetector detects a small amount of sunlight lower than the predetermined level (that is, in a cloudy or wet day, or during the night), the control unit will permit a current to be applied to the LED 362.

(10) In the previously described Embodiment 12, the light emission device thereof is constructed as a baton 500, according to which, only one second light emission section 530 is provided to one end of the long first light emission section 506. Instead thereof, a pair of substantially spherical light emission sections may be provided to the respective two opposite ends of such long first light emission section 506. Further, with regard to the Embodiments 1, 2, 5, 6 and 7, a substantially spherical shape of light emission section may be provided to one end or two opposite ends of the light emission device described in each of those embodiments.

(11) The previously described Embodiment 10 suggests formation of the substantially conical recession 404 in the transparent element. This is however one exemplary mode, and instead thereof, a substantially pyramidal recession be formed in the transparent element.

(12) The light emission device of the present invention may indeed be adaptable for use as: illumination for various kinds of testing operations; illumination inside and outside house; guide light; indicator lamp; emergency light; and the like. Further, the light emission device of the present invention may be incorporated as a constituent element in other various kinds of equipments and devices for versatile uses.

### INDUSTRIAL APPLICABILITY

In accordance with the present invention, a light emitted from a light source is applied to a transparent element having a curved surface region of substantially arcuate or circular shape in section, and the light is refracted and diffused therein due to a lens effect of such curved surface region. Hence, the present invention is applicable to various shapes and sizes of light emission devices. In particular, the invention is quite suited for a light emission device that are used in a light emitter required to provide a uniform and sufficient bright illumination

1. A light emission device characterized by comprising:
a transparent element having a curved surface region of substantially arcuate or circular shape in section, said transparent element having a property that allows substantive light to pass therethrough;
at least one light source for emitting and applying light to said curved surface region, said at least one light source being disposed adjacent to and out of contact with a surface of said transparent element, or disposed a predetermined distance from said surface of said transparent element, so as to allow said light to pass through said transparent element and radiate outwardly therefrom; and
a cover means provided on an outer surface of said transparent element, said cover means having said at least one light source accommodated therein.

2. The light emission device as described in claim 1, which is characterized in that a pair of said transparent elements are arranged in contact with each other in such a manner that the configuration thereof is changed stepwise along a direction in which said light is to be emitted outwardly from said light source, and wherein said cover means is so formed to cover surfaces of said pair of said transparent elements, excepting an outward light emission region associated with said pair of said transparent elements.

3. The light emission device as described in claim 2, which is characterized in that one of said pair of said transparent elements, which is disposed on a side corresponding to said light emission region, is larger in diameter than another of said pair of said transparent elements which is disposed on a side facing said light source.

4. The light emission device as described in claim 1, which is characterized in that said cover means has a heat radiation property.

5. The light emission device as described in claim 4, which is characterized in that a heat-conducting sheet is provided between said cover means and said light source.

6. The light emission device as described in claim 4, which is characterized in that said cover means is provided with a heat radiation fin(s) on the outer side thereof.

7. The light emission device as described in claim 1, which is characterized in that said cover means comprises a light scattering cover which is frosted or opaque, and said light scattering cover is adapted to cover the surface of said transparent element, excepting a light emission region defined in the surface of said transparent element, said light emission region being adapted for allowing the light to be emitted outwardly therefrom.

8. The light emission device as described in claim 7, which is characterized in that said light scattering cover is formed from a resin material or glass.

9. The light emission device as described in claim 8, which is characterized in that said resin material is a white acrylic resin material.

10. The light emission device as described in claim 1, which is characterized in that a plurality of said light sources are disposed along a longitudinal direction of said transparent element.

11. The light emission device as described in claim 1, which is characterized in that a frosted light scattering region is formed on a surface of said light emission region of said transparent element.

12. A light-emitting device, characterized by comprising:
a transparent element of substantially spherical shape having a property that allows substantive light to pass therethrough;
at least one light source for emitting light exteriorly of said transparent element and applying said light to said particular transparent element, wherein said at least one light source is disposed adjacent to and out of contact with an outer circumferential surface of said transparent element, or disposed a predetermined distance from said outer circumferential surface of said transparent element;
and
a tubular portion in which said at least one light source is accommodated, said tubular portion being defined on said outer circumferential surface of said transparent element.

13. The light emission device as described in claim 12, which is characterized in that a frosted light scattering region is formed on a substantially entirety of said outer circumferential surface of said transparent element, excepting an inner side of said tubular portion.

14. The light emission device as described in claim 12, which is characterized in that said transparent element has an light emission side from which said light is to be emitted outwardly therefrom, and that a recession of substantially conical or pyramid shape is formed in said transparent element on said light emission side, in such a manner that said recession diverges in a direction to said particular light emission side.

15. The light-emitting device as described in claim 14, which is characterized in that a substantially bell-shaped cover is provided so as to surround an outside of said transparent element and extend divergent from the transparent element in a direction to said light emission side.

16. A light emission device, characterized by comprising:
a transparent element of substantially semispherical shape having a property that allows substantive light to pass therethrough;
at least one light source for emitting light exteriorly of said transparent element and applying said light to said particular transparent element, wherein said at least one light source is disposed adjacent to and out of contact with a flat surface region of said transparent element, or disposed a predetermined distance from said flat surface region of said transparent element; and
a tubular portion in which said at least one light source is accommodated, said tubular portion being defined on and along a peripheral end of said flat surface region of said transparent element.

17. The light emission device as described in claim 12, which is characterized by being provided with: a first light emission section which includes said substantially spherical transparent element or said substantially semispherical transparent element, said at least one light source, and said tubular portion; and a second light emission section which is at least disposed at one end of said first light emission section.

18. The light emission device as described in claim 17, which is characterized in that said second light emission section comprises:
a lengthy configuration of transparent element having a property that allows substantive light to pass therethrough;
a transparent window defined in said transparent element so as to extend along a longitudinal direction of the transparent element;
a frosted light scattering region defined on surfaces of said transparent element, excepting said transparent window; and
a light source for emitting and applying light to said transparent element from at least one end of the transparent element.

19. The light emission device as described in claim 11, which is characterized in that said light scattering region is formed from a coating material containing a white pigment therein.

20. The light emission device as described in claim 1, which is characterized in that said light source is a light-emitting diode.

21. The light emission device as described in claim 1, which is characterized in that a solar battery is used as a power source for said light source.

22. The light emission device as described in claim 1, which is characterized in that a switch means is provided for causing said light source to either light on or go out in a selective way.

23. The light emission device as described in claim 1, which is characterized in that said transparent element is formed from a resin material or glass.

24. A light emitter using the light emission device described in claim 1.
